(19) United States
(12) Patent Application Publication
(10) Pub. No.: US 2004/0002438 A1
(43) Pub. Date: Jan. 1, 2004

(54) Solid- suspending systems

(76) Inventors: John Hawkins, South Staffordshire (GB); Edward Tunstall Messenger, Workington (GB); Zenaida Rivera-Healy, Worcestershire (GB); Richard Malcolm Clapperton, Worcestershire (GB); Mark Rollinson, Coseley (GB)

Correspondence Address: Rusell R Stolle, Huntsman Corporation, P O Box 15730, Austin, TX, 78761, US

(21) Appl. No.: 10/332,252

(22) PCT Filed: Jul. 4, 2001
(86) PCT No.: PCT/EP01/07661

(30) Foreign Application Priority Data
Jul. 6, 2000 (GB) 0016522.5
Aug. 5, 2000 (GB) 0019161.9
Aug. 12, 2000 (GB) 001981.4
Oct. 6, 2000 (GB) 0026171.9
Nov. 18, 2000 (GB) 0028186.5
Dec. 21, 2000 (GB) 0031173.8
Feb. 13, 2001 (GB) 0103476.8
Mar. 6, 2001 (GB) 0105426.1
Mar. 13, 2001 (GB) 0106118.3
Apr. 10, 2001 (GB) 0108940.8
May 26, 2001 (GB) 0112889.1
Jun. 12, 2001 (GB) 0114256.1

(51) Int. Cl. C11D 17/00

(52) U.S. Cl. 510/417

(57) ABSTRACT

Structured surfactant systems with solid suspending properties comprise a substantially non-aqueous liquid continuous phase and a structuring surfactant capable of forming an Lα phase in said continuous liquid phase at a concentration between 10 and 20% by weight solid surfactant preferably comprising at least two hydrophobic C7-30 aliphatic groups per molecule, said groups preferably comprising bent chain groups such as cis monounsaturated alkenyl e.g. erucyl or singly branched alkyl e.g. isopalmityl.

The present invention relates to structured surfactants having solid-suspending properties which are not dependent on the presence of a continuous aqueous phase.

Structured Surfactant

Suspending solids or other insoluble or immiscible phases in liquids presents a problem. If the solids differ in density from the liquid they will tend either to sediment or float. Increasing the viscosity of the liquid can retard, but not prevent such separation, and high viscosities are generally undesirable. Colloidal systems, in which the suspended particles are sufficiently small to experience Brownian motion, e.g. less than 1 micron, may be kinetically stable. However the difficulty or undesirability of comminuting some solids to such sizes, and the impossibility of maintaining many of them at this level in the face of crystal growth or agglomeration, limits the use of colloidal suspensions.

Adjusting the density of one phase to match that of the other is usually impracticable. Moreover such systems are almost always temperature-unstable due to differential rates of thermal expansion.

One approach which allows non-colloidal particles to be suspended is referred to in the art as “structuring”. The use of external structurants such as polymers which are not required in the formulation for any purpose other than to maintain its homogeneity has been found unsatisfactory. They do not provide adequate suspending power, except at the expense of an unacceptable increase in viscosity, and/or they increase the cost of the formulation without improving its performance. The alternative is to use an intrinsic ingredient of the formulation to confer structure (“internal structuring”). This approach has led to the development of a method of suspension which permits even relatively large particles to be stably and economically suspended and is generally referred to as “structured surfactant”. The term covers systems comprising a surfactant mesophase, usually of the type which is often called a lamellar or G-phase, but which, in accordance with modem practice will be referred to herein as an Lα phase. The mesophase in a structured surfactant is usually interspersed with an aqueous phase. Structured surfactant systems typically exhibit a yield stress which is sufficient, when the system is at rest, to immobilise any suspended particles, but which is sufficiently low to allow the system to be poured like a normal liquid. Such systems may display very low apparent viscosities when stirred, pumped or poured and yet be capable of maintaining particles, sometimes of millimetre or larger size, indefinitely in suspension.

Three main types of suspending system have been employed in practice, all involving an Lα-phase, in which bilayers of surfactant are arranged with the hydrophobic part of the molecule on the interior and the hydrophilic part on the exterior of the bilayer (or vice versa). The bilayers lie side by side, e.g. in a parallel or concentric configuration, usually separated by aqueous layers. L_{α} phases can usually be identified by their characteristic textures under the polarising microscope and/or by x-ray diffraction, which is often able to detect evidence of lamellar symmetry. Such evidence may comprise first, second and sometimes third order peaks with d-spacing

$$\frac{2 \prod }{Q}$$

(where Q is the momentum transfer vector) in a simple integral ratio 1:2:3. Other types of symmetry give different ratios, usually non integral.

The d-spacing of the first peak in the series corresponds to the repeat spacing of the bilayer system.

Most surfactants form an Lα-phase either at ambient or at some higher temperature when mixed with water in certain specific proportions, typically between 40 and 80% by weight of surfactant based on the weight of surfactant and water. They have shear dependent (non-Newtonian) viscosity with a distinct yield point. However such conventional Lα-phases do not usually function as structured suspending systems. Useful quantities of solid render them unpourable and smaller amounts tend to sediment.

The main types of structured system used in practice are based on (i) dispersed or bicontinuous lamellar, (ii) spherulitic and (iii) expanded lamellar phases. Dispersed or bicontinuous lamellar phases are two phase systems in which the surfactant bilayers are arranged as parallel plates to form domains of Lα-phase which may be dispersed in or interspersed with an aqueous phase to form a gel-like system which is normally opaque. They are described in EP 0 086 614.

Spherulitic phases comprise well defined spheroidal bodies, usually referred to in the art as spherulites or lamellar droplets in which surfactant bilayers are arranged as concentric shells. The spherulites usually have a diameter in the range 0.05 to 20 microns, more usually 0.1 to 10 microns, and are dispersed in an aqueous phase in the manner of a classical emulsion, but interacting to form a structured system. Spherulitic systems are described in more detail in EP 0 151 884.

Many structured surfactant systems are intermediate between dispersed lamellar and spherulitic, involving both types of structure. Usually systems having a more spherulitic character are preferred because they tend to have lower viscosity.

A variant on the spherulitic system comprises prolate or rod shaped bodies sometimes referred to as batonettes. The latter have generally been believed to have a concentric cylindrical structure analagous to that of spherulites or possibly to comprise a row of spherulites enclosed within a tubular sheath. Batonettes have therefore been considered by most authorities to be a type of dispersed Lα-phase. Some evidence suggests that batonettes may exhibit hexagonal symmetry since they sometimes give typical H-phase textures under the microscope, when crushed. For the avoidance of doubt the term “L∝ phase” will be used herein to include batonettes irrespective of whether they can be proved to have a lamellar structure or even if they are demonstrably hexagonal, provided that they are capable of forming a stable suspension of solid particles with a viscosity less than 11.5 Pas. However batonettes are generally not preferred because they confer relatively high viscosity. The viscosity usually depends on the length of the batonettes, as well as the density with which they are packed.

A third type of structured surfactant system comprises an expanded Lα-phase. It differs from the other two types of structured system in being essentially a single phase, and from conventional Lα-phase in having a wider d-spacing. Conventional Lα-phases, which typically contain 60 to 75% by weight surfactant, have a d-spacing of about 4 to 7 nanometers. Attempts to suspend solids in such phases results in stiff pastes which are either non-pourable, unstable or both. Expanded Lα-phases with d-spacing greater than 8, e.g. 10 to 15 nanometers, form when an electrolyte is added to aqueous surfactants at concentrations just below those required to form a normal Lα-phase, particularly to surfactants in the H-phase, which is also referred to in earlier literature as the “hexagonal” “middle” or “M-phase”. The H₁-phase comprises surfactant molecules arranged to form cylindrical rods of indefinite length. It exhibits hexagonal symmetry and a distinctive texture under the polarising microscope. Typical H₁-phases have so high a viscosity that they sometimes appear to be curdy solids. H₁-phases near the lower concentration limit (the L₁/H₁-phase boundary) may be pourable but have a very high viscosity and often a mucous-like appearance. Such systems tend to form expanded Lα-phases particularly readily on addition of sufficient electrolyte. We do not exclude the possibility that some batonette-like structures may have hexagonal symmetry and thus be a form of H₁-phase.

Expanded Lα-phases are described in more detail in EP 0 530 708. In the absence of suspended matter they are normally translucent, unlike the majority of dispersed lamellar or spherulitic phases. These phases usually involve structures larger than the wave length of visible light and are therefore opaque. Expanded Lα-phases are optically anisotropic and have shear dependent viscosity. In this they differ from L₁-phases which are micellar solutions and under which heading we include microemulsions. L₁-phases are clear, optically isotropic and substantially Newtonian. They are unstructured and cannot suspend solids. Some L₁-phases exhibit small angle x-ray diffractograms which show evidence of hexagonal symmetry. Such phases usually have concentrations near the L₁/H₁-phase boundary and may form expanded Lα-phases on addition of electrolyte or, transiently, on application of pressure or shear stress. Expanded Lα-phases are sometimes less robust than spherulitic systems. They are liable to undergo a phase change when cooled to relatively low temperatures to give a non-space filling, opaque dispersion of spherulite-like bodies which usually lacks suspending power. Expanded L∝ phases often exhibit a relatively low yield stress, which may limit the maximum size of particle that can be stably suspended.

Most structured surfactants require the presence of electrolyte as well as surfactant and water in order to form structured systems capable of suspending solids. However certain relatively hydrophobic surfactants such as isopropylamine alkyl benzene sulphonate can form spherulites in water in the absence of electrolyte. Such surfactants are capable of suspending solids in the absence of electrolyte as described in EP O 414 549.

A problem with the two phase structured surfactant systems, and especially spherulitic systems, is flocculation of the dispersed surfactant structures. This tends to occur at high surfactant and/or high electrolyte concentration. It can have the effect of making the composition very viscous and/or unstable with the dispersed surfactant separating from the aqueous phase.

Certain amphiphilic polymers have been found to act as deflocculants of structured surfactants. One type of deflocculant polymer exhibits cteniform (comb-shaped) architecture with a hydrophilic backbone and hydrophobic side chains or vice versa. A typical example is a random copolymer of acrylic acid and a fatty alkyl methacrylate. Cteniform deflocculants have been described in a large number of patents, for example WO-A-9106622.

A more effective type of deflocculant has surfactant (linear) rather than cteniform architecture, with a hydrophilic polymer group attached at one end to a hydrophobic group. Such deflocculants are typically telomers formed by telomerising a hydrophilic monomer with a hydrophobic telogen. Examples of surfactant deflocculants include alkyl thiol polyacrylates and alkyl polyglycosides. Surfactant deflocculants are described in more detail in EP 0 623 670.

WO 01/00788 describes the use of small amounts (e.g. about 15% by weight of the composition) of carbohydrates such as sugars and alginates as deflocculants in structured surfactant compositions. The latter comprise surfactant, water and electrolyte in proportions adapted to form flocculated two-phase structured surfactant systems in the absence of the carbohydrate.

The use of deflocculent polymers can give rise to syneresis. The spherulitic suspending medium shrinks in volume leaving a clear portion of the continuous phase external to the spherulitic suspending medium. In conventional, aqueous, structured systems, in which the surfactant is normally less dense than the aqueous phase, this usually manifests itself as a clear lower layer (“bottom separation”). Various auxiliary stabilisers have been suggested to inhibit or prevent syneresis or bottom separation of structured surfactant. For example U.S. Pat. No. 5,602,092 has proposed the use of highly cross linked polyacrylates, while WO 01/00779 describes the use as auxiliary stabiliser of non-cross linked polymers with a hydrophilic back bone and sufficient short (e.g. C₁₋₅) hydrocarbon side chaims to enhance physical entanglement of the polymer molecules, e.g. polymers of acrylic acid with ethyl acrylate.

Clays such as bentonite or synthetic layered silicates have also been used as auxiliary stabilisers, either alone or in conjunction with polymers.

WO 01/00780 describes the use of high molecular weight ethoxylates in conjunction with thiocyanates as auxiliary stabilisers inhibiting or preventing loss of structure at elevated temperatures.

A particular type of highly expanded Lα-phase which is more robust than most electrolyte-structured L∝ phases, and which has good suspending properties and sometimes may exhibit a clear appearance, can be obtained using sugar as the structurant instead of electrolyte as described in WO 01/05932.

The use of deflocculant polymers to prepare clear spherulitic or other dispersed Lα structured systems by shrinking the spherulites or other Lα domains to a size below the wave length of visible light has been described in WO 00/63079, which also describes the use of sugar to modify the refractive index of the aqueous phase as an alternative means of obtaining clear liquids.

Application

Structured surfactants have been applied to the problems of suspending: water insoluble or sparingly soluble builders in laundry detergent; antifoams and enzymes in laundry detergents and other surfactant systems; abrasives in hard surface cleaners; pesticides and oils in agrochemical preparations (EP O 388 239 and EP O 498 231); rock cuttings in drilling muds (EP O 430 602); dyestuffs in dyebath concentrates and printing inks (EP O 472 089); talcs, oils and other cosmetic ingredients in personal care formulations (EP O 530 708). The present invention is applicable to many of the foregoing. It is particularly applicable to laundry detergents and especially detergents containing oxidising bleach and/or enzymes, to detergents for industrial and institutional use, especially in conjunction with washing machines having automatic detergent dosing equipment, and for detergents in unit dose form such as water soluble sachets or capsules. It is useful for suspending substances, such as pesticides, which exhibit crystal growth when stored in water, and generally for applications in which water or other solvents are undesirable. It may also be applied, for example, to personal care products such as hair creams, pharmaceutical products such as drug delivery systems, to flavourings and other concentrates for the food industry and to toothpastes. The invention is applicable to the improvement of lubricating oils e.g. by suspending solid lubricants such as graphite, by inhibiting the precipitation of sludge and by enhancing their EP properties.

The Problem

A common feature of existing solid-suspending systems, which is a serious disadvantage for many applications, is the necessity to include water, usually in excess of 50% of the weight of the composition. The term “structured surfactant” as used hitherto has always implied the existence of a continuous, or cocontinuous aqueous phase. Apart from the obvious disadvantage to the manufacturer, distributor and consumer of having to transport and store a bulk of water which is larger than that of the active ingredients, the presence of water has placed severe limitations on the freedom of formulators to include water sensitive ingredients. In particular, despite many attempts over the past twenty years, nobody has succeeded in stably suspending peroxy bleach in aqueous liquid detergent. Although many different methods of stabilisation have been described, and relatively long half lives of oxidising bleach have been claimed in the literature, the stabilisation has never been sufficiently reliable to permit a commercial product. Similar problems are encountered with enzymes, which deteriorate rapidly in the presence of aqueous surfactant and/or alkaline builders.

A stable liquid detergent containing bleach, bleach activator and enzymes reliably suspended would be particularly valuable in the institutional and industrial, as well as the domestic markets in permitting washing machines to be designed with a single reservoir from which liquid detergent could be metered into each wash.

Another long standing problem associated with the presence of water is the provision of liquid formulations, such as laundry detergents in unit dose form. Unit doses of, for example, laundry or automatic dishwash detergent which can be added directly to a washing machine or dishwasher, and which avoid the need to measure out appropriate quantities using e.g. a measuring cup, are popular with consumers. This has led to the commercial success of unit dose tablets formed by compacting powder detergents. Powder detergents dissolve more slowly than liquid detergents and this problem is exacerbated when they are compacted into tablets. A number of attempts to formulate water soluble unit doses containing liquid detergent using PVA or other water soluble sachets (e.g. U.S. Pat. No. 60373 19) or gelatin or other water soluble capsules (e.g. EP0339707) have so far failed to provide a stable and economical alternative to tablets. Problems have included seepage through the water soluble sachet or capsule or other deterioration on storage, and the high cost of the solvents normally required for the liquid formulations, in an attempt to prevent such deterioration or seepage. Solids cannot be included because they separate to form unsightly and slow-dissolving crusts on the inside of the sachet.

Attempts to supply liquid detergents in anhydrous form have generally relied on the presence of organic solvents such as alcohols, glycols or polyglycols. These have a number of disadvantages. The solvents are expensive but make no contribution to the washing performance and they are often difficult to dilute. In particular they cannot be internally structured to provide stable suspending systems. Lack of structure prevents solids being stably suspended in the formulations.

Attempts have been made to structure anhydrous liquid surfactants by using external structurants, usually in the form of polymers or clays such as bentonite, or synthetic layer silicates. Like solvents, polymers are expensive and are extrinsic to the formulation. They make no contribution to performance in the end use, but merely preserve homogeneity during storage. They are generally less effective in providing the desired combination of good suspending power and low viscosity than structured surfactants. Clays tend to make the formulation undesirably viscous, and the structure is liable to collapse when the chemical environment is modified.

A further problem is the tendency of existing liquid detergents and aqueous structured surfactant systems to form a crust on storage due to evaporation of the water or other solvent.

The Discovery

Surprisingly we have now discovered that it is possible to make stable L∝ structured systems capable of suspending solids which do not exhibit a continuous aqueous phase and which can therefore be formulated in the absence, or substantial absence, of water. In one preferred embodiment stable compositions are obtained which are also free from non-surfactant organic solvents such as ethanol or polyethylene glycol, wherein the liquid suspending medium consists essentially of surfactants.

We believe that, in principle, any surfactant can be obtained in a structured form in non-aqueous liquid media and that any non-aqueous liquid can provide the medium for a structured surfactant. We have discovered that in order to form a structured system the surfactant should have the right degree of solubility in the medium and be present in an appropriate concentration. To obtain a structured system with a given surfactant, it is generally necessary to choose a liquid medium with the appropriate polarity to permit the formation of a suspending L∝ phase. For a given surfactant in a given medium it is often necessary to use a co-surfactant to obtain a surfactant mixture with the correct solubility in the particular medium to form a structured surfactant system.

In general surfactants form solid-supporting structured systems when sufficient surfactant is out of solution in the composition to form a packed dispersion of L∝ phase in the continuous liquid medium. Depending upon the surfactant and the medium this typically occurs when from 10 to 20% by weight of the composition of the structuring surfactant is present, although some structured systems may be able to form with as little as 4% of structuring surfactant, and others with as much as 35%.

To determine the optimum composition for a structured system, a structuring-surfactant should therefore be used at a concentration between 10 to 20%. If the structuring-surfactant is too soluble to provide a structured system, it may be possible to obtain such a system by increasing the concentration, but if a satisfactory system cannot be obtained in this way then the polarity of the medium may be lowered, e.g. by progressively adding a non-polar solvent such as mineral oil, until a structured system is obtained. Alternatively the solubility of the structuring surfactant may be lowered by mixing it with progressively increasing proportions of a desolubiliser, e.g. a less soluble surfactant, to obtain a surfactant mixture with the appropriate mean solubility.

Conversely if the structuring-surfactant is too insoluble the polarity of the liquid medium may be raised by progressively adding a more polar liquid such as high ethoxylated non-ionic surfactant or polyethylene glycol, or a lower molecular weight hydroxylic solvent such as ethylene glycol mono methyl ether, diethylene glycol monomethyl ether, isopropanol, ethylene glycol or glycerol.

Alternatively the solubility of the insufficiently soluble structuring-surfactant may be raised by mixing it with a solubiliser such as more soluble structuring-surfactant.

If the structured system obtained following the procedure outlined above is too viscous for the particular application for which it is required, usually due to the formation of excessively long batonettes, the structuring surfactant may be replaced by a speherulite-forming surfactant having bent hydrophobic groups as disclosed hereinafter.

In general the structuring-surfactant should desirably have a solubility in the continuous phase greater than 1% by weight, usually greater than 2% by weight, preferably greater than 3% by weight more preferably greater than 4% by weight. It should have a solubility less than 30% more preferably less than 25% most preferably less than 20% usually less than 15% often less than 12% e.g. less than 10% by weight.

The term “solubility” in the above context refers to the phase boundary between the substantially clear solutions, or micellar solutions, and the appearance of the L∝ or H phase.

We have discovered that surfactants which are sufficiently insoluble in an anhydrous liquid medium can be dispersed in said anhydrous liquid medium, to form structured systems. Such systems are usually present in the form of batonettes, or crystals which have good solid suspending properties and we have now found that they are useful for certain specific applications including soluble unit dose sachets and extrudable pastes. Surfactants which have at least two long chain (e.g. C₇₋₃₀) hydrophobic aliphatic groups per molecule are particularly preferred.

The medium is generally a non-ionic and preferably relatively non-polar liquid which may consist of or comprise a hydroxylic organic compound. The latter may be a hydroxylic organic solvent and/or, preferably, a non-ionic surfactant such as a liquid alkyl ethoxylate. The structuring-surfactant is typically an ionic or relatively polar surfactant, and may, for example, comprise, (i) anionic or cationic surfactants, with divalent counterions, i.e. in the form of salts of a divalent base or metal, or of a divalent acid respectively; (ii) ionic surfactants in which the surfactant ion has two hydrophobic aliphatic groups; (iii) surfactants with a heteropolar character which can dimerise such as amine oxides and amphoteric surfactants or (iv) surfactants formed from a surfactant anion and a surfactant cation. Although preferably ionic in character the structuring-surfactant may alternatively be or comprise a non-ionic surfactant.

In the present context “relatively non-polar” means not ionising in water and less polar in character than amine oxide; “relatively polar” means more polar in character than a C₈ alcohol eight mole ethoxylate.

A disadvantage of structured surfactant systems based on batonettes in their relatively high viscosity. Such systems are generally too viscous to be of commercial interest for many potential applications of anhydrous structured liquids. We have, however discovered that some systems with relatively small batonettes are more mobile.

Surprisingly we have discovered, that structuring-surfactants of the above types in which the hydrophobic aliphatic groups comprise a relatively high proportion of groups with a bent configuration, due to a single non-linear structural feature, preferably located at or near the centre of the chains such as a cis double bond, or lower hydrocarbon branch, are particularly effective at forming low viscosity, non-aqueous spherulitic systems. Surprisingly surfactants having mono unsaturated alkenyl groups in the cis configuration (e.g. those obtained from feedstocks which comprise high proportions of oleic, erucic, palmitoleic, ricinoleic, or other mono unsaturated alkenoic acids in the cis configuration) and/or of singly branched chain fatty alkyl, such as isostearic or isopalmitic acid, form spherulites more readily than feedstocks containing exclusively straight chain saturated, polyunsaturated or trans monounsaturated hydrophobic aliphatic groups. The latter tend to form highly viscous systems based on batonettes and/or crystals.

Where the polar group of the surfactant is a homopolar group as in an anionic or cationic surfactant, and especially where the salt is to be formed in situ by reacting a base with the precursor acid, the formation of spherulites is facilitated by the presence of a hydroxylic compound. For such surfactants the continuous phase may consist essentially of a liquid non-ionic surfactant or a hydroxylic solvent or may comprise a solution of non-ionic surfactant and/or other hydroxylic organic compound in a hydrophobic or hydrophilic, substantially non-aqueous solvent.

The hydroxyl groups can also be provided by small amounts of water which is preferably incorporated into the spherulites, which are dispersed in a continuous, substantially non-aqueous liquid phase. Alternatively or additionally the water may be present in micelles directly dispersed in the continuous, substantially non-aqueous, liquid phase.

Heteropolar surfactants such as amphoteric surfactants or amine oxides do not usually require the presence of a hydroxylic compound in order to form spherulites. They are generally able to provide spherulitic systems in oil solvents such as kerosene or medicinal paraffin oil.

The Invention

According to one embodiment the invention provides a structured surfactant composition having solid suspending properties and comprising a substantially non-aqueous continuous liquid phase and a structuring-surfactant which is present in excess of its solubility in the continuous phase and is present as an L∝ phase. Preferably said structuring-surfactant is present as batonettes, spherulites and/or expanded lamellar phase. Said structuring-surfactant is preferably either an anionic or cationic surfactant with at least two C₇ to ₃₀, hydrophobic aliphatic groups per molecule or a heteropolar surfactant with at least one such group per molecule. Said hydrophobic aliphatic groups preferably comprise at least a major proportion of bent chain groups. Said continuous phase is preferably an organic liquid and is preferably relatively non-polar, and said structuring-surfactant is preferably relatively polar in character.

According to a second embodiment the invention provides a structured surfactant composition as aforesaid wherein the continuous liquid phase comprises more than 50% by weight thereof, and preferably more than 70% most preferably more than 80% by weight thereof, of non-ionic surfactant.

According to a third embodiment the invention provides a substantially non-aqueous suspension comprising a structured surfactant composition as aforesaid and a non-colloidal particulate phase which is immiscible with the continuous liquid phase and which is held in suspension by the structured surfactant.

According to a preferred embodiment the invention provides a structured surfactant composition comprising: (A) a substantially non-aqueous continuous phase preferably comprising an organic liquid and; (B) a spherulite-forming surfactant which is either (i) a cationic or anionic surfactant having at least two C₇ to ₃₀ hydrophobic aliphatic groups per molecule or (ii) a heteropolar surfactant, such as an amphoteric surfactant or amine oxide, having, in its monomeric form, at least one such aliphatic group; said aliphatic group or said groups comprising from 5 to 100%, based on the total weight of said groups of aliphatic groups having a bent configuration. The bent groups may comprise one or more monounsaturated alkenyl groups in the cis configuration and/or one or more singly branched chain alkyl groups and/or one or more other aliphatic groups comprising a single C₇ to ₃₀ aliphatic chain interrupted by a single group which is chemically stable in the composition and which confers a non-linear configuration on the chain, said spherulite-forming surfactant being at least predominantly present either as spherulites, optionally including a minor proportion of batonettes, or as expanded L∝-phase dispersed in or interspersed with said substantially non-aqueous continuous phase.

Preferably said aliphatic groups comprise groups of the formula:

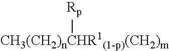

Wherein R is C₁₋₄ alkyl or hydroxyalkyl, R¹ is a (═CH) group in the cis configuration, n and m are each from 1 to 20 such that (n+m) is from 4 to 27 and p is 0 or 1,

Preferably, particularly where the spherulite-forming surfactant is an anionic or cationic surfactant, the composition comprises a hydroxylic compound which is chemically compatible with said surfactant and which is present as part of said spherulites and/or as, or as part of, said organic liquid. Preferably the organic liquid is a relatively non-polar liquid and in particular, at least for detergent formulations, one which comprises, or more preferably consists of, a hydroxylic organic compound, which is most preferably a non-ionic surfactant.

According to a specific embodiment the invention provides a structured surfactant composition comprising a substantially non-aqueous, non-onic, relatively non-polar, liquid medium and a relatively polar surfactant which comprises a divalent metal (preferably calcium) salt of an aliphatic phosphonic, sulphuric, sulphonic or carboxylic acid comprising at least 5% and preferably at least 10% based on the weight of the composition of a C₇₋₃₀ cis mono unsaturated alkenyl group or branched chain alkyl group. Said composition preferably comprises sufficient of a hydroxylic compound to provide at least 0.5 preferably at least 1, e.g 1.5 to 3 moles hydroxyl per mole of divalent metal.

Particularly preferred according to this specific embodiment are the calcium salts of cis mono unsaturated fatty acids and especially of oteic and/or erucic acids; and/or of singly branched saturated fatty acids such as isostearic or isopalmitic acid. Also very effective are calcium salts of oleyl, isosteryl, isopalmityl and/or erucyl sulphuric acid.

According to a second specific embodiment the invention provides a composition comprising a substantially non-aqueous, non-ionic liquid medium and a spherulite-forming surfactant which is present in excess of its solubility in said medium, said surfactant comprising an alkaline earth metal, alkali metal, ammonium or mono- or diacidic amine salt of the mono- and/or diester of a tribasic acid, such as phosphoric acid, said ester comprising C₇₋₃₀ bent chain hydrophobic aliphatic groups such as cis monounsaturated C₇₋₃₀ alkenyl groups or branched chain alkyl groups which constitute at least 5% and preferably at least 10% of the total weight of the composition.

Particularly preferred according to the second specific embodiment are calcium and/or diamine, e.g. ethylene diamine, salts of bent chain C10 to 25 hydrophobic aliphatic esters or ether esters of phosphoric acid, for example cis-monounsaturated alkenyl or cis monounsaturated alkenylether phosphates, e.g. oleyl, oleyl ethoxy or oleyl polyethoxy esters.

According to a third specific embodiment the invention provides a composition comprising a substantially non-aqueous, relatively non-polar, liquid medium and a relatively polar spherulite-forming surfactant which is sufficiently polar to be substantially insoluble in said medium to form an L∝ phase dispersed therein or interspersed therewith, said surfactant comprising a dipolar surfactant such as an amphoteric surfactant or amine oxide, said dipolar surfactant comprising bent chain hydrophobic aliphatic groups such as cis monounsaturated C10-25 alkenyl groups or singly branched chain alkyl groups, which constitute at least 5% preferably at least 10% of the weight of the composition.

The splierulite-forming surfactant according to the third embodiment may for example be a cationic or anionic surfactant having a surfactant cation or surfactant anion respectively with one long bent chain aliphatic group wherein the counter ion of said ionic surfactant comprises a divalent ion, e.g. in the case of an anionic surfactant a divalent metal ion such as calcium or diacidic organic base such as ethylene diamine, or in the case of a cationic surfactant, a dibasic acid.

Alternatively the spherulite-forming surfactant ion may itself have two long chain aliphatic groups, such as, for example, in a phosphate diester or cationic fabric conditioner. The spherulite forming surfactant may have more than two bent long chain aliphatic groups, as in the calcium salts of acids having more than one aliphatic group per molecule e.g. dioleylphosphoric acid, or mixtures of acids having an average of between one and two groups per molecule.

The dispersed surfactant may alternatively be an aggregate of a cationic with an anionic surfactant or, preferably a dipolar surfactant such as an amphoteric surfactant or amine oxide.

According to a fourth specific embodiment the invention provides a structured surfactant composition comprising; (A) a continuous phase consisting of a substantially anhydrous, organic liquid; (B) a structuring-surfactant comprising (i) an anionic or cationic surfactant having at least two hydrophobic aliphatic groups with from 7 to 30 carbon atoms per molecule, (ii) an amphoteric surfactant, (iii) an amine oxide and/or (iv) a surfactant anion and a surfactant cation, said structuring surfactant being present as an L∝ phase dispersed in or interspersed with said continuous phase; and (C) a water sensitive particulate material stably suspended in said continuous phase by said structuring surfactant.

According to said fourth specific embodiment the continuous phase may consist essentially of non-ionic surfactant. The structuring-surfactant is preferably a spherulite-forming surfactant as described herein and is preferably present at least predominantly as spherulites. The water sensitive material may, for example, be a bleach such as sodium perborate or sodium per carbonate, an enzyme, a hydrateable solid such as a partially moisturised phase 1 sodium tripolyphosphate or a mixture which effervesces in water such as citric acid/sodium bicarbonate.

Bent Chain Aliphatic Feedstock

We have found that structuring-surfactants having alkyl groups which are derived from exclusively straight chain saturated feedstocks do not normally disperse in organic liquids as stable spherulites. Instead they form very viscous systems containing batonettes, or somtimes crystals. However structuring-surfactants having two aliphatic groups which are derived from feedstocks containing C₇₋₃₀ bent chain aliphatic groups tend to form low viscosity spherulitic compositions. Surfactants which have a tendency to form spherulites are referred to herein as “spherulite-forming surfactants”. Bent chain aliphatic groups are hydrocarbon chains of from 7 to 30 e.g. 12 to 25 and preferably 14 to 20 carbon atoms which have a single non-linear group located at or near the centre which imposes a bend on the chain. The group is preferably an ethylenic double bond in the cis conformation or a low molecular weight (e.g. C₁₋₄) alkyl preferably methyl, group but may also be for example a keto, ester or amido group. The hydrophobic part of the molecule may comprise a group of the formula:

CH₃(CH₂)ₙX(CH₂)ₘ

wherein n and m are each from 3 to 15, preferably 4 to 12 e.g. 5 to 10 and X a is non-linear non-hydrophilic group having from 1 to 4 carbon atoms such as cis-CH═CH, or

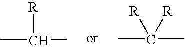

group, where R is C₁₋₄ alkyl, preferably methyl, or a

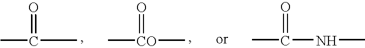

group. Aliphatic groups containing one or more double bonds in the trans conformation or containing a plurality or non-linear groups do not exhibit the same behaviour, nor do aliphatic groups having non-linear groups located at or very near the end of the aliphatic chain, or at least not to the same extent.

For example the spherulite-forming surfactant may be based on a feedstock containing singly branched alkyl groups and/or mono unsaturated alkenyl groups in the cis configuration, having at least 8 preferably at least 10, e.g. 12 to 24 carbon

For some purposes we prefer feedstocks derived from erucic acid which is available in more than 90% purity from rape seed oil. Oleic acid, although more widely available is only readily available in relatively impure (70%) form, however it generally provides formulations which exhibit a lower set point than erucic acid. Mixtures of oleic acid and erucic acid have been found to give particularly good results.

The aliphatic groups may alternatively or additionally comprise branched chain saturated alkyl groups, e.g. those having a short e.g. methyl, ethyl, propyl or isopropyl branch at or near the centre of a long, e.g. C₁₂₋₂₀, chain for example isostearyl. “Isostearyl” is used herein to refer to the predominantly mono methyl branched C₁₈ alkyl which is the principal C₁₈ by product of the dimerisation of C₁₈ unsaturated acids. Also useful is isopalmitic acid obtained by dimerising octanal.

Typically the short chain alkyl substituent is linked to a carbon atom which is located more than two, preferably more than three, especially more than four, ideally more than 5, usually more than 6 e.g. from 7 to 12 places from the nearer end of the aliphatic carbon chain. Examples include 8-methyl heptadecanoic acid, 8-ethyl heptadecanoic acid, 7-ethyl pentadecanoic acid, 7-methyl pentadecanoic acid, 7-methyl hexadecanoic acid, 7-ethyl hexadecanoic acid, 8-methyl hexadecanoic acid, 8-ethyl hexadecanoic acid, 8-methyl octadecanoic acid, 8-ethyl octadecanoic acid and mixtures thereof.

The minimum mole weight of the hydrophobic aliphatic group should not be so low as to render the molecule too soluble in the continuous medium. Depending on the nature of the latter and the nature of the hydrophilic group and the number of hydrophobic groups we usually prefer hydrophobic aliphatic groups having a total of more than 8, more preferably more than 10, most preferably more than 12, typically more than 14 and often more than 16 aliphatic carbon atoms. Generally the average total number of aliphatic carbon atoms in the hydrophobic aliphatic groups in each structuring-surfactant molecule is greater than 20, more preferably greater than 25 most preferably greater than 28, especially greater than 30, more especially greater than 32, most especially greater than 34. The total number of hydrophobic aliphatic groups per molecule is preferably an average of from 1.5 to 5, especially 2 to 4.

Without wishing to be bound by any theory we believe that a single cis double bond or short chain alkyl substituent or other non-linear group located at or near the centre of an alkyl chain confers a bent configuration which favours spherulite formation, whereas unbranched, saturated alkyl; polyunsaturated and transunsaturated alkenyl groups and alkyl groups with more than one branch all tend to adopt a substantially straight configuration which favours the formation of batonettes. For convenience therefore aliphatic groups possessing such single non-linear features are referred to herein as “bent”.

We particularly prefer that the spherulite-forming surfactant should have bent chain hydrophobic aliphatic groups linked to an ionic hydrophilic group by oxyalkylene or polyoxy alkylene groups, especially polyoxyethylene groups having from 1 to 20 preferably 3 to 10 ethoxy groups. The presence of ethyleneoxy moieties in the aliphatic group may tend to increase the solubility of the structuring-surfactant. Ethyleneoxy groups should not therefore constitute too high a proportion of the molecular weight of the structuring-surfactant, at least where the continuous medium is an ethoxylated non-ionic surfactant. The maximum number or ethyleneoxy groups will depend on the total number of carbon atoms in the hydrophobic aliphatic groups. The polyoxyethylene chain should not therefore be sufficiently long to solubilise the structuring surfactant in the continuous medium, but is preferably long enough to provide a wide spread of chain lengths. We believe that this inhibits flocculation of the spherulites and reduces syneresis, and may also tend to promote the formation of robust spherulites.

Proportions

The total proportion of spherulite-forming surfactant is preferably from 50 to 100% by weight of the total ionic or dipolar surfactant more preferably 75 to 100%. The proportion of bent chain hydrophobic aliphatic group is preferably from 10 to 100%, more preferably greater than 15 especially greater than 20 more especially greater than 40%, typically greater than 50% usually greater than 75% e.g. greater than 90% based on the total weight of hydrophobic aliphatic groups in the structuring-surfactant.

The proportion of the structuring-surfactant is usually greater than 3%, preferably greater than 8% by weight of the suspending system (excluding suspended solids) more preferably greater than 10% most preferably greater than 15%. It is preferably less than 60% by weight based on the weight of the suspending system, more preferably less than 50% most preferably less than 40% typically less than 35% e.g. less than 30%.

The proportion of spherulite-forming surfactant is preferably sufficient to form a packed spherulitic system. This usually requires at least 5% spherulite-forming surfactant e.g. at least 10%, especially more than 14%, sometimes more than 18%, based on the weight of the composition. Usually the proportion of spherulite-forming surfactant is less than 60%, preferably less than 50% more preferably less than 40% most preferably less than 30%, often less than 25% based on the total weight of the composition.

Anionic Surfactant

The structuring-surfactant is preferably an anionic surfactant. The anionic surfactant preferably comprises or consists of a spherulite-forming surfactant, and in particular an alkaline earth metal salt, especially a calcium salt of a mono and/or di (C₇₋₃₀ cis mono unsaturated alkenyl, single branched alkyl, cis mono unsaturated alkenyl ether, singly branched alkyl ether, singly branched alkanoyl ether or cis mono unsaturated alkenoyl ether) ester of phosphoric acid. The commercially available products are mixtures of mono and di esters. We believe that the principal active spherulite forming agent is the di-ester, although the monoester almost certainly contributes and we do not exclude the possibility that its contribution may predominate. Typical examples are the phosphate esters of oleic, isostearic, isopalmitic or erucic acid 1 to 20 mole ethoxylates, especially 2 to 15 most preferably 6 to 12 mole ethoxylates. Oleyl phosphate esters and oleyl or oleic acid ether phosphate esters are particularly effective spherulite-forming surfactants in non-ionic surfactant based media and their salts with other bases, such as ethylene diamine, also readily form spherulites.

Alternatively or additionally the anionic structuring-surfactant may be, or may comprise the calcium salt of a preferably C₈₋₂₅ cis mono unsaturated or other bent carboxylic acid such as calcium oleate, palmitoleate, isostearate or erucate, or mixtures thereof or less preferably, mixtures of the foregoing with palmitate, stearate, dodecanoate, linoleate, linolenate, ricinoleate or other salt of a straight or branched chain, saturated or unsaturated carboxylic acid or, preferably a mixture of carboxylic acids having an average of from 8 to 25, preferably 10 to 24, especially 12 to 22, carbon atoms. Cis monounsaturated acids such as oleic, palmitoleic and erucic and especially mixtures of oleic and erucic are strongly preferred. However mixtures of fatty acids containing a substantial proportion of cis mono unsaturated fatty acids, such as uncut and unhardened coconut, palm or tallow fatty acids are also operative. Other structuring-anionic surfactants which may be present include calcium cis mono unsaturated alkenyl (or mixed alkyl/alkenyl) ether sulphates, alkenyl benzene sulphonates, alkenyl sulphates, olefin sulphonates, alkenyl sulphosuccinates, dialkenyl sulphosuccinates, alkenyl ether sulphosuccinates, alkenolamide sulphosuccinates, alkenyl sulphosuccinamates, alkenyl sarcosinates, alkenyl taurides, alkenyl isethionates, alkenyl phenol sulphates, alkenyl phenyl ether sulphates, alkenyl ether carboxylates and alkenyl phenyl ether carboxylates. In each case the surfactant preferably comprises an 8 to 25 carbon cis mono unsaturated alkenyl group or mixture of such groups with alkyl, polyunsaturated alkenyl or polypropyleneoxy groups. Alkyl or alkenyl groups may be straight and preferably have from 10 to 24 eg. 14 to 22 carbon atoms. However branched chain and or secondary alkyl or alkenyl groups may additionally or alternatively be present. For example isostearic acid or other C₁₂₋₂₂ saturated fatty acids having a methyl, ethyl, propyl or isopropyl substituent on a C₁₁₋₂₁ chain, and especially a methyl or ethyl group attached to one of the middle or adjacent to middle carbon atoms function in a similar manner to the cis unsaturated acid.

Ether groups in any of the foregoing anionic surfactants may comprise glyceryl groups and/or 1 to 50 preferably 1 to 20 oxyethylene groups (e.g. 2 to 10 mole ethoxylates) and/or 1 to 10 propoxy groups. The anionic groups usually comprise a phosphate or carboxylate group but may alternatively comprise for example a sulphate, sulphonate, or phosphonate group.

In addition to the divalent metal ion or divalent base, the counter ions of the anionic surfactant may comprise ions of sodium, potassium, lithium, ammonium or a monovalent organic base such as isopropylamine, monoethanolamine, diethanolamine or triethanolamine.

We prefer that the anionic surfactant be prepared in situ by reacting the precursor acids with calcium hydroxide or other divalent base e.g. magnesium hydroxide, calcium oxide or a mixture of calcium hydroxide and calcium oxide. In situ neutralisation forms water of neutralisation, which we believe contributes to the spherulitic structure.

We strongly prefer that the divalent metal is calcium but it may alternatively or additionally comprise other alkaline earth or other divalent metal salts for example magnesium. Generally, the salts of larger alkaline earth or divalent metal ions such as barium or zinc with two moles of the anionic surfactant precursor acids are not as readily prepared as the calcium salts, since direct neutralisation of the precursor acids with hydroxides of the former normally results in the formation of basic mono acid salts. Because of this, and on commercial grounds we do not envisage such salts being used in practice other than for special applications. However, if required, the diacid salts may be prepared by reacting alkaline earth chlorides with the precursor acids in alkaline solution and drying the product. The conventional, fully dried products may not contain sufficient moisture to form spherulites as readily as do calcium salts prepared in situ. We prefer that the salts be only partially dried or, most preferably, when possible, that they be prepared in situ. Alternatively or additionally there may be present a divalent organic base such as ethylene diamine, diaminohexane or piperazine. Trivalent or tetravalent metals or bases such as aluminium, tin or diethylene triamine could in theory be present and are not excluded, but are unlikely to be used on commercial grounds. They are unlikely to be cost effective or environmentally acceptable in comparison with calcium, but might conceivably be required for some specialised application.

The proportion of divalent metal or base is preferably above the minimum required to provide a stable system. Usually the amount is between 10 and 100% by weight of the total cation e.g. more than 20% especially more than 30%, more especially greater than 40% most especially greater than 50%, typically more than 60%, more typically greater than 70% most typically greater than 80%. The total proportion of base may be from 50 to 150% of the precursor acid of the anionic surfactant, preferably 70 to 120% more preferably 80 to 110% e.g. 90 to 105% on an equivalent weight basis. Typically the proportion is stoichiometric based on the precursor acid.

An alternative to the use of anionic surfactants with divalent cations as the spherulite-forming surfactants is the use of anions having two long chain aliphatic groups with monovalent cations, for example di-(cis monounsaturated alkenyl) phosphates or di(cis monounsaturated alkenyl) sulphosuccinates of alkali metals, such as sodium, lithium or potassium, ammonium or a lower amine or alkanolamine having up to six carbon atoms, such as di-tri or preferably monoethanolamine, or isopropylamine.

Non spherulite-forming or less readily spherulite forming anionic surfactants including sodium, potassium, isopropylaiine, ammonium and alkanolamine salts of saturated and/or unsaturated fatty acids, alkyl benzene sulphonic acids, alkyl sulphuric acids, alkyl ether sulphuric acids or any other of the classes of anionic surfactant discussed above or their straight chain alkyl analogues may be present in the compositions of our invention, provided that there is sufficient structuring-surfactant and, preferably, sufficient spherulite-forming surfactant, and that the proportion of non-spherulite forming anionic surfactant is not so high as to render the composition too viscous for the particular application.

Cationic Surfactant

The structuring surfactant may be, or may include cationic surfactants, and especially cationic fabric conditioners. The latter, typically have two hydrophobic aliphatic groups, usually tallowyl groups, which, in the unhardened form, comprise a cis unsaturated component (oleyl). They are therefore, capable of forming spherulites in the anhydrous continuous liquid phase. Cationic fabric conditioners usually comprise a cationic group such as a quaternary ammonium or phosphonium substituted with a short chain alkyl and/or benzyl groups and two long chain aliphatic groups normally comprising tallowyl groups. Examples of cationic fabric conditioners which can be used as spherulite-forming surfactants include ammonium salts of the type [R₂NR¹R²]⁺ X⁻ where each R is a C₁₄ to 25 aliphatic group comprising a cis monounsaturated alkenyl group or singly branched alkyl group, R¹ is a C₁ to ₄ alkyl or hydroxyalkyl group e.g. methyl, ethyl or hydroxyethyl, R² is the same as R¹ or a benzyl group and X is an anion such that the salt is substantially insoluble in, but chemically compatible with, the composition. Alternatively the fabric conditioner may be or may comprise an amido amine or imidazoline, preferably having two long chain cis monounsaturated alkenyl, singly branched alkyl or mixed alkyl/alkenyl groups.

Other cationic surfactants include quaternary ammonium salts of the formula n[RNR¹₂R²]⁺Xⁿ⁻ where R,R¹,R² and X have the same significance as before and n is the valency of X, and is preferably 2, as well as amido amines and imidazolines having a single C₈₋₂₅ hydrophobic aliphatic group preferably comprising a cis monounsaturated alkenyl or singly branched alkyl group.

The counterion of the fabric conditioner may be chloride, methosulphate, bromide, formate, acetate or lactate. However we prefer, in case of cationic surfactants with only one long chain alkyl group per cationic group, to employ a divalent counterion such as sulphate, tartrate, maleate, succinate, malonate or malate. The counter ion may also comprise a tribasic acid such as citrate or phosphate.

Non spherulite-forming analogues of all the above classes of surfactant may also be included in the compositions of our invention.

Amphoteric Surfactant

The structuring surfactant may comprise an amphoteric surfactant, preferably a betaine. It is well known that there is a range of amphoteric fabric conditioners analogous to the cationic fabric conditioners discussed above and having two long chain hydrophobic groups per molecule. It is consistent with the behaviour of the corresponding cationic fabric conditioners that these are effective as structuring-surfactants. Moreover since they normally comprise tallow groups containing oleic acid it is also consistent with our invention that they are able to function as spherulite-forming surfactants. However, we have found that conventional amphoteric surfactants, with a single C₁₀₋₂₀ aliphatic group also have good structuring properties, and can form spherulites when the aliphatic group is bent.

Examples of amphoteric surfactants which are of value in the present invention include betaines of the formula: RR¹₂N⁺CHCOO⁻, wherein R is an aliphatic hydrocarbyl group hydrocarbyl amido alkyl or hydrocarbyl ether group comprising a cis monounsaturated alkenyl group or singly branched alkyl group having an average of from 6 to 25, e.g. 8 to 24 aliphatic carbon atoms and R¹ is an alkyl or hydroxy alkyl group having an average of from 1 to 4 carbon atoms. Particularly preferred is uncut, unhardened coconut amido propyl betaine (CAPB) or any of the corresponding alkyl and alkenyl amido propyl betaines derived from natural palm or coconut fatty acids or from synthetic carboxylic acids having a similar alkyl chain distribution often loosely referred to as CAPB. We particularly prefer amido propyl betaines prepared from oleic and/or erucic acid. Also useful are oleic acid rich fractions.

Alternatively we may use the so-called quaternary imidazoline betaines, also called ampho acetates, and traditionally ascribed the formula:

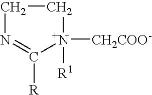

although they are actually present, at least predominantly, as the corresponding linear amido amine

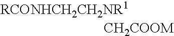

which is usually obtained commercially in admixture with the dicarboxymethylated form

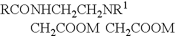

wherein R is an aliphatic group having from 8 to 25 carbon atoms and comprising a cis mono-unsaturated alkenyl group and R¹ is an alkyl or hydroxyalkyl group with from 1 to 4 carbon atoms. Other amphoteric surfactants for use according to our invention include alkenyl amino propionates, alkenylamine polyalkoxy sulphates, sulphobetaines, amido sulphobetaines, phosphobetaines and other quaternary amine or quaternised imidazoline sulphonic acids and their salts, and Zwitterionic surfactants, e.g. N-alkenyl taurines, carboxylated amido amines such as RCONH(CH₂)ₙN⁺ R¹₂CH₂CO⁻₂ where n is 2 to 4, and amino acids having, in each case, at least one aliphatic group having from 8 to 25 carbon atoms and comprising a cis monounsaturated alkenyl group

The effectiveness of many of the foregoing betaines may at first sight seem surprising since they do not apparently exhibit the characteristic of having two long chain aliphatic groups per molecule which we believe is required for optimum structuring or spherulite formation according to the invention. Without wishing to be bound thereby we suggest that this may be explained by the following theory:

We propose that betaines may tend to dimerise, particularly in substantially anhydrous systems, to form a surfactant aggregate having two long chain alkyl or alkenyl groups arranged according to the formula

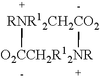

where R is an organic group comprising a C₆₋₂₅ aliphatic hydrocarbyl group comprising a cis monounsaturated group and/or a singly branched alkyl group and R¹ is a lower alkyl e.g. C₁₋₄. Two or more of these hypothetical dimers could be stacked one above the other and/or side by side to form higher polymers, or a lamellar array which we believe would readily form spherulites or Lα-phases in liquid non-ionic surfactants.

We do not exclude the use of betaines having two long chain cis monounsaturated alkenyl or singly branched alkyl groups, for each undimerised betaine molecule, e.g. carboxymethylated his (C₁₅₋₁₈ alkyl amido ethyl) amine, as the spherulite forming agent. Betaines may be used as the sole spherulite-forming surfactant, alternatively they may be used in conjunction with, for example, calcium soaps or phosphate ester salts. The proportion of spherulite-forming betaine or the total proportion of spherulite-forming betaines and spherulite-forming anionic surfactants may be substantially as hereinbefore described with respect to the calcium soaps.

Amphoterics are particularly useful in detergents on account of their soil removing properties. We therefore prefer, even when amphoterics are not required to provide the spherulite-forming surfactant, that non-spherulite-forming amphoteric surfactants such as alkyl betaines should be included in the formulation.

To avoid introducing excessive amounts of water and electrolyte to the system we prefer to use desalted or low salt, and at least partially dehydrated, e.g. vacuum or freeze dried, amphoterics.

Amine Oxides

Amine oxides, including amido amine oxides behave in an analogous manner to amphoteric surfactants. Amine oxides derived from cis monounsaturated C₁₀₋₂₅ alkenyl amines, singly branched alkylamnines or other bent feedstock have the ability to form spherulites in non-aqueous liquid media. We believe that this may involve a mechanism analogous to that observed with amphoteric surfactant, e.g.:

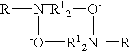

Where R is an aliphatic group having from 8 to 25 carbon atoms and comprising a cis monounsaturated alkenyl group and R¹ is a C₁₋₄ alkyl or hydroxy alkyl group and preferably a methyl or ethyl group.

Amine oxides, like amphoteric surfactants have excellent soil removal characteristics.

We therefore prefer, even if not required as the spherulite-forming surfactant, to include amine oxides, e.g. C₈₋₂₅ alkyl dimethyl amine oxides in compositions of our invention.

Anionic Cationic Aggregates

Aggregates formed by a cationic and an anionic surfactant can also be used as structuring-surfactants to form spherulite. For example we may use aggregates of the type:—

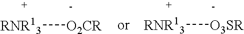

wherein each R is independently a C₇₋₃₀ aliphatic hydrocarbyl group, preferably comprising a cis monounsaturated alkenyl group and each R¹ is independently a C₁₋₄ alkyl or hydroxyalkyl group. Any of the anionic surfactants hereinbefore described may, in principle, be combined with any of the cationic surfactants hereinbefore described, to form an aggregate having two long chain cis monounsaturated alkenyl or branched alkyl groups. For example methylated triethanolamine erucyl ester and erucic acid form a spherulitic complex

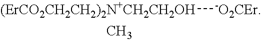

Continuous Medium

The continuous medium of the composition of the invention is a substantially anhydrous, preferably organic, liquid medium. Where the spherulite-forming surfactant is an anionic or cationic surfactant we prefer, for optimum stability of the structure, that the medium should comprise a hydroxylic compound. The latter is preferably a non-ionic surfactant, but may additionally or alternatively be, for example a hydroxylic solvent such as an alcohol, glycol, or glycol ether, or a carbohydrate. In the absence of a non-surfactant solvent the non-ionic surfactant must, of course, comprise sufficient of a surfactant which is liquid at ambient temperatures to provide a liquid surfactant mixture. This normally requires the presence of relatively low molecular weight alcohol ethoxylates such as C₈₋₁₄ alkyl 1 to 8 mole ethoxylate in a proportion sufficient to dissolve any other non-ionic surfactant present.

Alternatively the continuous medium may comprise a hydroxylic solvent or a carbohydrate. If required for fluidity or for functional reasons, a non-hydroxylic solvent may additionally or alternatively be present. It is a particular feature of the invention that solvents are not necessary for stability and that the composition may consist essentially of functional washing ingredients such as surfactant, builder and bleach. However if it is decided to include a solvent for functional reasons, such as compositions for removing heavy oily or greasy soils, or if a relatively high proportion of normally solid non-ionic surfactant is required, the system is highly tolerant of such solvents, unlike normal, aqueous based structured surfactant systems. It is possible, though not usually preferred, to use small amounts of water to provide the hydroxylic compound. We believe that any water is mainly incorporated in the spherulites rather than in the continuous medium.

Amphoteric surfactants and amine oxides do not require the presence of hydroxylic compounds to form spherulites. The continuous medium may consist of hydrophobic solvents such as kerosene, medicinal paraffin or other mineral oils or a glyceride oil, silicone, terpene, aromatic solvent or fatty ester.

All reference herein to physical states are to the states existing at normal temperature and pressure wherever the context permits. However we do not exclude the possibility that the continuous phase may be, or may comprise, a pressure liquified gas such liquid petroleum gas e.g. liquid propane or butane or liquid carbon dioxide, or a fluoro carbon.

Nonionic Surfactant

Where the continuous phase consists essentially of surfactant, the latter preferably comprises, at least predominantly a non-ionic surfactant which is liquid at ambient temperature and preferably comprises an alkyl or alkenyl 1 to 8 mole ethoxylate. Higher ethoxylates (e.g. up to 60 mole) may be present in admixture with either the lower ethoxylates or a solvent, provided the mixture is liquid. In general we prefer mixtures of two or more ethoxylates with different polyoxyethylene chain lengths. The alkyl or alkenyl group may be straight or branched chain and have from 8 to 25, more usually 10 to 20 e.g. 12 to 14 carbon atoms.

Other non-ionic surfactants which may be present include fatty acid ethoxylates, alkyl phenyl ethoxylates, alkyl or alkenyl amine ethoxylates, glyceryl or sorbitan ester ethoxylates, polyoxypropylene/oxyethylene block copolymers, ethoxylated phosphate esters, alkanolamides such as coconut mono- or di-ethanolamides, ethoxylated alkanolamides, alkyl polyglycosides, sugar esters and capped ethoxylates. Ethoxylates typically contain from 2 to 40 eg. 3 to 30 especially 5 to 15 oxyethylene groups.

Other Hydroxylic Compounds

Apart from hydroxylic non-ionic surfactants, the continuous phase may additionally or alternatively comprise hydroxylic solvents such as methanol, ethanol, ethylene or propylene glycol, glycerol, glycol ethers such as ethylene glycol monomethyl ether, diethylene glycol mono methyl ether, diethylene glycol or polyethylene glycols having an average of from 2 to 100, more preferably 3 to 50, especially 4 to 30 e.g. 5 to 20 ethyleneoxy groups, pentaerythritol, trimethylol propane or poly glycerols. Additionally or alternatively the hydroxylic compound may be or may comprise other hydroxylic organic compounds such as carbohydrates. For example mono saccharides, disaccharides or oligosaccharides including sucrose, fructose, glucose galactose, maltose, mannose, ribose, deoxyribose, arabinose, xylose, lyxose, rhamnose, allose, gulose, idose, talose, lactose, erythrose, tlueose, acrose and altrose and soluble starches or reduced sugars such as mannitol, acritol or sorbitol may be present either in admixture with hydroxylic solvents and/or surfactants or dissolved in non-hydroxylic solvents. It is strongly preferred that the hydroxylic compound be an organic hydroxylic compound but it is possible to obtain spherulites using a small amount of water as the only hydroxylic compound.

A particular aspect of our invention provides the use of hydrogen peroxide as the hydroxylic compound. Hydrogen peroxide incorporated into the spherulites provides a highly stable bleach and disinfectant which may be used as an environmentally friendly toilet cleaner or sterilent.

Non-Hydroxylic Solvent

For many purposes we prefer that compositions of our invention contain no non-surface active solvents, since solvents generally add to the cost of cleaning formulations without contributing to their performance, and may be undesirable on environmental grounds.

However the system is tolerant of the presence of a wide variety of solvents unlike aqueous structured surfactants, which tend to be destabilised by even very low levels of solvent. If desired e.g. if there is a requirement to incorporate non-liquid non-ionic surfactants, to lower the set point or viscosity of the composition, or if the composition is intended for removal of heavy soil such as grease, tar or engine oil, or for lubricants the composition may comprise a non-hydroxylic solvent. For example ketones such as acetone, esters such as ethyl acetate may be present. Water immiscible solvents such as aliphatic mineral, glyceride, fatty ester, silicone, terpene or aromatic hydrocarbon oils may be present, as, or as part of, the continuous phase or dispersed in the system as suspended droplets, according to miscibility with the other components.

We generally prefer that non-hydroxylic solvent constitutes less than 90%, typically less than 80% e.g. less than 75% of the weight of composition and is more preferably a minor amount, e.g. less than 50% of the weight of non-ionic surfactant.

Preferably, when not required for a specific purpose, the total non-surfactant solvent is less than 20% based on the weight of the composition more preferably less than 15%, most preferably less than 10%, especially less than 5% e.g. less than 3%.

Water

The compositions of the invention are substantially non-aqueous. By “substantially non-aqueous” is meant that the continuous liquid phase contains less than 15% desirably less than 10%, generally less than 8%, especially less than 7%, typically less than 6%, usually less than 5%, more usually less than 4%, most commonly less than 3% preferably less than 2%, most preferably less than 1% e.g. less than 0.5% by weight moisture based on the weight of the phase. The amount of water that can be tolerated varies according to the nature and use of the formulation. For some applications the presence of small amounts of water dissolved or dispersed as micelles in the continuous phase is acceptable or even desirable, because it facilitates the preparation of a stable spherulitic phase. However, when it is desired to suspend water sensitive materials such as oxidising bleach in the formulation we prefer that the continuous phase should be substantially anhydrous. By this we mean that the water in the continuous phase is less than 1%, preferably less than 0.5% most preferably less than 0.1% e.g. less than 0.05% by weight of the composition.

It is possible to add sufficient water to the composition to optimise the formation of a stable spherulitic suspending medium and then to remove it from the continuous phase prior to adding the water sensitive material, by drying or by use of a dessicant. Typically the addition of 2 to 10% e.g. 4 to 8% of water by weight of the composition is helpful in forming the suspending system. The latter may be vacuum dried or mixed with a dessicant such as anhydrous, or preferably slightly moisturised, sodium tripolyphosphate or sodium carbonate. The moisturised tripolyphosphate typically contains from 1 to 8% of water by weight thereof e.g. 2 to 6% and a high proportion of the more readily hydrated phase 1 form. The composition may be stirred, or allowed to stand, with dessicant for sufficient time to allow the water in the continuous phase to be absorbed, e.g. 1 to 20 hours before adding the water sensitive component.

Even when water sensitive materials are to be included, the composition as a whole may contain small amounts of water, e.g. formed by the neutralisation of the acid precursors of the anionic surfactant, provided that such water is included in the spherulites, or, as water of crystallisation of any solid phase present. The water may provide any hydroxylic compound which may be required.

Any water present in the continuous phase is usually present as the dispersed portion of an L₂ phase.

Preferably the total water in the composition, excluding water of crystallisation in any suspended solid present, is less than 10% by weight more preferably less than 8%, most preferably less than 5% e.g. 0.01 to 3% desirably less than 2% ideally less than 1% e.g. less than 0.5%.

Electrolyte

The term “electrolyte” is used herein to denote water soluble compounds which dissociate into ions, at least partially, and which tend to salt out surfactants from solution in water. Electrolytes are generally relatively insoluble in compositions of the invention. The presence of dissolved electrolyte is not normally required for structuring but is generally tolerated if required for other purposes. We particularly prefer electrolyte-free or low electrolyte (e.g. 0.5 to 5% by weight) compositions for many applications but can tolerate higher levels. For example industrial cleaning formulations may require alkali such as sodium hydroxide, carbonate or silicate. The presence of builders such as citrate, potassium pyrophosphate, or sodium tripolyphosphate may also be tolerated. Any electrolyte is, however, usually present mainly as suspended matter. Small amounts of alkali metal salts e.g. sodium or preferably potassium chloride may be present, from the use of sodium or potassium hydroxide in promoting the neutralisation of anionic precursors with calcium, or other alkaline earth halides.

Hydrotropes

The term “hydrotropes” is used herein to denote water soluble compounds which tend to increase the solubility of other solutes in water.

The presence of hydrotropes is not normally required in compositions of the invention, however their presence may be tolerated more readily than by aqueous structured systems. They may be desirable to promote rapid dilution with water or dissolution of the suspended solid on dilution. Hydrotropes may be present in solution in the continuous phase, or if insoluble in the continuous phase, as suspended matter. Hydrotropes include sodium benzene sulphonate and lower alkyl benzene sulphonates having 1 to 6 aliphatic carbon atoms such as toluene, xylene and cumene benzene sulphonates, napthalene sulphonates and also compounds such as urea,. We prefer that the compositions contain less than 10% more usually less than 5% e.g. less than 2% by weight of hydrotropes.

Polymers

Compositions of this invention may contain polymers, but are not dependent upon polymers for their suspending structure. We do not exclude the use of polymers in an auxiliary role to confer increased stability or robustness or to act as deflocculants or auxiliary stabilisers (e.g. preventing top separation), however the polymers are not desirably present in amounts sufficient to provide a stable suspending structure in the absence of surfactants. We prefer that the surfactant is present in a sufficient amount to provide a suspending structure in the absence of polymer. We prefer that the composition contain less than 10%, more preferably less than 5%, especially less than 2%, more especially less than 1% e.g. less than 0.5% of structuring polymer. Structuring polymers are preferably absent since they are expensive and generally have no useful function for the end user.

Other polymers such may optionally be present for functional reasons include drying oils or film forming polymers for use in paint formulations, viscosity modifiers, e.g. for lubricant applications, and soil release polymers and soil suspending agents such as carboxy methyl cellulose for detergent compositions.

Suspended Matter

The composition may contain suspended solid, liquid or gaseous particles. Solid particles, in particular, but also suspended liquid droplets or gas bubbles, may help to pack the system and may be added to partially packed systems in any amount consistent with pourability. For example amounts of suspended solid from 1 up to 60% by weight are readily suspended in spherulitic structured systems of the invention to provide mobile compositions. Higher amounts may be added but tend to make the composition more viscous. The amount of suspended matter and preferably of suspended solid is usually between 10 to 50% especially 20 to 40% e.g. 25 to 35% by weight. Suspensions having a tendency to separate may often be stabilised by adding more suspended matter, especially solids.

We particularly prefer to suspend particles of water sensitive materials such as oxidising bleach. For example it is possible to make stable suspensions of per salts such as sodium perborate, percarbonate or perphosphate. There may also be present an organic peroxide such as a peroxycarboxylic acid e.g. peroxyacetic peroxydodeconoic, peroxyphthalic or peroxybenzoic. The peroxy organic may optionally be present in solution in the continuous phase. Peroxides such as hydrogen peroxide or chlorine bleaches such as sodium hypochlorite or chloroisocyanurate may also be present. The bleach is even stable in the presence of activators such as tetracetyl ethylene diamine which may also be suspended. Enzymes such as protease, lipase, amylase or cellulase may be suspended with reduced risk of deactivation on storage. It is even possible to suspend bleach and enzyme in the same formulation. Products which are difficult to suspend in aqueous systems due to crystal growth may also be suspended in surfactant systems of the present invention. These include sparingly water-soluble pesticides such as amitraz.

The structured suspending systems of the invention may also be used to suspend builders such as zeolite, sodium tripolyphosphate, potassium pyrophosphate, sodium carbonate, sodium or potassium citrate or phosphonates or buffers or enzyme stabilisers such as borates, pyroborates or metaborates for detergent systems, abrasives such as calcite for scouring creams, agricultural and horticultural pesticides, herbicides, plant growth regulators and fertilisers, biocides for water treatment, rock cuttings or shale in drilling muds, mineral ores for transport through pipelines antifoams, explosives, gums such as xanthan and guar gum, solid fuels such as powdered coal and machining and cutting abrasives such as emery or diamond powder.

The composition may contain liquefied propellant gas dispersed in order to provide foams such as shaving foam, on release from a pressurised pack.

Other particulate solids which may be suspended include personal care products e.g. exfoliants such as talc, clays, polymer beads, sawdust, silica, seeds, ground nutshells and dicalcium phosphate, pearlisers such as mica or glycerol or ethylene glycol distearate, glitter additives and sunscreens such as titanium dioxide. Porous particles (so called micro-sponges) containing absorbed active ingredients or gelatin or other microcapsules may also be suspended, permitting the inclusion in the formulation of ingredients which are chemically incompatible with the surfactant, and/or other components of the formulation.

Other active ingredients which may be suspended include insect repellents and topical or other pharmaceutical or veterinary preparations, e.g. preparations for treatment of acne, fungicides for athlete's foot or ringworm or antiseptics, antibiotics, antiinflammatories, analgesics or antihistamines.

Pigments, such as the iron oxides, titanium oxide, carbon black and particles designed to provide a decorative effect, e.g. coloured speckles, may also be added.

Droplets of surfactant-imuniscible liquids may be suspended e.g. mineral, terpene, ester or glyceride oils, silicones, greases and resins.

Suspended matter may also comprise ferromagnetic particles such as ferrite, spinels or ferromagnetic alloys.

Where sodium tripolyphosphate is suspended, the polyphosphate tends to retain its original phase ratio. It is therefore possible to suspend mixtures of any desired ratio of phase 1 to phase 2 tripolyphosphate in order to control the rate of solution of the composition in water. The tripolyphosphate may also absorb moisture from the composition by forming the hexahydrate and be used as desiccant.

Detergent Auxiliary Ingredients

Liquid detergents according to the invention preferably contain up to 15% by weight total of auxiliary ingredients in addition to surfactant, builder and any bleach. For example silicone or other antifoams, soil anti redeposition agents such as sodium carboxymethyl cellulose, optical brighteners, dyes, preservatives, soil release polymers, enzymes, sequesterants such as phosphonates, fragrances, clays such as bentonite, bleach activators, photoactive bleaches, deflocculants, dispersants and similar conventional ingredients may be present. Usually the total weight of such auxiliary ingredients is less than 5% by weight of the formulation.

Alkali

Detergent composition of our invention may require the presence of alkali for optimum effectiveness. The alkalinity may be provided in part by tripolyphosphate and/or zeolite builders, but additional alkali is usually desirable. Alkalinity may be provided by sodium carbonate, sodium silicate or sodium hydroxide, which may be, at least partly, suspended in the structured liquid.

Preferably, for laundry detergent, there should be sufficient alkali to provide a pH, on dilution to a concentration of 0.5% by weight in water of from 9 to 12 e.g. 10 to 11.

The composition preferably has sufficient alkalinity to require from 0.3 to 12 ml. preferably 3 to 10 ml, of N/10 HCI to reduce the pH of 100 ml of an aqueous solution containing 0.5% by weight of the composition, to 9.

Opacifiers

Compositions of the invention may undergo some syneresis, i.e. separation of part of the continuous phase. This does not adversely affect the utility of the system for many purposes, e.g. unit dose sachets, but may affect the appearance of the product. This may be ameliorated or avoided by he use of opacifiers. The latter are typically inert particles of colloidal dimensions, e.g. polymer beads such as polystyrene which are larger than the wavelength of visible light but small enough (e.g. smaller than one micrometer) to be kinetically stable. Such colliodal particles remain dispersed throughout the continuous phase, even if the gel phase shrinks, and preserve the overall opacity of the system.

Deodorising Systems

It is well known that nitric oxide is effective deodorant for body odours. The composition of the invention allows the inclusion of deodorising systems based on a water soluble nitrite such as sodium nitrite and an acidulant such as citric acid which generate nitric oxide on dilution with water. This constitutes a further aspect of the invention.

Fabric Conditioners

Fabric conditioners are often added to rinse water, after the main wash to counteract the harshness which repeated washing in anionic surfactants may induce in fabrics. Such fabric conditioners typically comprise an aqueous solution of a cationic or, less preferably, an amphoteric surfactant with two relatively long chain fatty groups, usually tallowyl groups, per molecule. Because they are chemically incompatible with anionic surfactants it is not normally practical to include cationic fabric softeners together with the main wash detergent.

Various clays such as bentonite or synthetic layer silicates may be used instead of cationic or amphoteric conditioners to exert a softening effect. They are less effective than cationic conditioners, but unlike cationic conditioners may be included in anionic powder detergent formulations to provide “built in” softening. They may also be suspended in aqueous structured liquid detergents. The cationic “fabric softeners” hitherto marketed for post wash addition have been relatively dilute, e.g. containing less than 30% by weight active fabric conditioners, usually less than 20%. It has not proved possible to prepare reliably stable and pourable Lα or other suspending systems, and therefore the use of solid auxiliary conditioners has not been practicable.

The present invention provides a concentrated anhydrous cationic and/or amphoteric fabric conditioning formulation comprising a non-aqueous liquid medium and at least one cationic and/or amphoteric fabric conditioner comprising at least two C₁₀₋₃₀ hydrophobic aliphatic groups per molecule said aliphatic groups, comprising at least 5% by weight thereof, preferably at least 20% e.g. more than 50% of bent chain aliphatic groups said conditioner being present at least in part as a stable spherulitic or expanded Lα system. Optionally the fabric conditioner of the invention may contain auxiliary solid conditioners such as bentonite or synthetic layer silicates suspended in the composition.

It is possible to combine a fabric conditioning system based on cationic, amphoteric and/or layer silicates with an amphoteric structured laundry formation of the invention to give a softergent product.

Water Soluble Unit Dose Systems

The novel anhydrous structured surfactant systems of the invention are especially suitable for encapsulation in water soluble capsules or packaging in water soluble sachets to provide rapidly water soluble unit doses. So far the only commercially available “liquid tablets”, as the laundry sachets are commonly called, comprise unstructured clear liquids. This severely limits the range of desirable ingredients which can be included to those which are soluble in the formulation. Any insoluble solids tend to form an unacceptable crust on the inside of the sachet. Thus it has not been possible to include effective builders such as sodium tripolyphosphate or zeolite, which are required for cost effective soil removal, bleaches such as sodium perborate required for effective stain removal or fabric softeners such as bentonite.

We have now found that L∝ structured formulations of the invention may be encapsulated or enveloped in a water soluble non-fluid encapsulant or film which is preferably impervious to the liquid non-ionic surfactants, solvents or other components of the continuous phase of the composition.

The invention therefore provides, according to a further embodiment, a water soluble unit dose composition comprising a water soluble outer layer which is non-fluid and non-plastic at normal ambient temperature and a core comprising a substantially anhydrous structured surfactant system comprising, liquid, non-ionic surfactant having dispersed therein as an L∝-phase, a cationic, amphoteric or anionic surfactant or amine oxide which is present in excess of its solubility in the liquid non-ionic surfactant. The dispersed surfactant preferably has at least two C₇ to 25 hydrophobic aliphatic groups per molecule, and/or is an amphoteric surfactant or amine oxide having at least one hydrophobic aliphatic group per molecule. Said aliphatic groups preferably comprise a bent chain group, as described herein.

The outer layer may comprise a sachet formed from a water soluble film forming polymer such as polyvinyl alcohol, partially hydrolysed polyvinyl acetate, or an alginate, which may be filled and sealed in conventional manner. Alternatively the substantially anhydrous liquid detergent may be encapsulated, e.g. in a water soluble encapsulant such as gelatin or other soluble protein such as casein or albumen, polyethylene glycol, polyvinyl pyrrolidone, a soluble cellulose derivative such as carboxymethyl cellulose or hydroxypropyl cellulose, a soluble gum such as guar gum, gum benzoin, gum arabic, gum tragacanth or gum acacia, or a carbohydrate such as dextrose, starch, galactose, amylose or an amylopectin.

Where bleach is included in soluble sachets it is important to avoid any reaction between water and bleach since even relatively small evolution of oxygen causes the sachet to inflate, and may cause bursting of the sachet. We have found that in practice it is difficult to ensure no moisture is present. However we have found that presence of a small amount of amine e.g. in the form of an amine soap has a stabilising effect. Primary and secondary amines may be used but tend to form oximes which give rise to discolouration. However tertiary amines such as triethanolamine stabilise the bleach without discolouration.

According to a special embodiment the invention provides a water soluble sachet which contains a liquid detergent composition comprising a substantially anhydrous-organic liquid continuous phase, a structuring surfactant present as L∝-phase dispersed in or interspersed with said continuous phase, an oxidising bleach and a tertiary amine.

It is possible to incorporate effervescent salt mixtures such as sodium citrate and sodium bicarbonate into the unit dose sachet or capsule to provide a “bath bomb” which effervesces on addition to bath water. By including amphoteric and other high foaming surfactants, a foaming bath bomb can readily be formulated.

It is sometimes possible to incorporate minor ingredients which are incompatible with the liquid formulation in the outer layer.

Agrochemical Suspensions

The present invention provides a novel means of suspending relatively water-insoluble biocidal or agrochemical active substances in a form which is readily dispersible in aqueous media without the need to employ environmentally harmful solvents. The term “agrochemical” is used herein broadly to cover chemicals that kill, entrap, repel or inhibit growth or reproduction of unwanted organisms (“pests”) or which protect or promote the healthy growth or reproduction of wanted organisms such as crops, ornamental plants, livestock and domestic animals, and which are useful in agriculture, horticulture, forestry, animal husbandry, water treatment and land management, e.g. for application to fields, crops, orchards, livestock, gardens, woodland, hedgerows, parks, industrial estates, construction sites, airports, roads, railways, rivers, lakes, ponds, canals, irrigation and drainage works and the like.

Pests include vertebrate vermin such as rodents, rabbits and pigeons, invertebrates such as insets, mites, slugs, snails, nematodes, flatworms, millipedes and pathogenic protozoa, weeds, fungi, moulds, bryophites, lichens, algae, yeasts, bacterial and viruses.

“Biocidal and agrochemical active substances” include substances intended to kill, entrap, repel or to prevent or inhibit the growth or reproduction of any or all of the aforesaid pests. They also include growth promoters such as hormones, auxins, giberellins, nutrients, trace elements for application to soil or crops and biocides for use in water treatment such as boiler water, process water, cooling water, oil field injection water, central heating and air conditioning systems, but excludes animal foodstuffs and veterinary preparations for internal administration.

A number of substantially water insoluble biocidal and agrochemical active substances, are used extensively for controlling pests and/or for promoting the healthy growth of crops and livestock. For this purpose it is usually necessary or preferred to apply them in a fluid and preferably a diluted form. This frequently requires that the active substances be formulated in a stable concentration suitable for dilution with water.

For many years the only practical approach to formulating many of the less water soluble agrochemicals was to dissolve them in an organic water-immiscible solvent usually an aromatic hydrocarbon such as xylene or isophorone and emulsify the resulting organic solution in water. A major disadvantage of this method is that the solvents commonly used are undesirable ecologically and from the stand point of human safety. Only the lack of a practicable alternative means of formulating many agrochemicals prevented severe restrictions on the use of such solvents.

Other approaches to the problem of applying some of the less water soluble agrochemicals included the formulation of wettable powders or dispersible granules, both of which present problems for the user of handling solids and dispensing them in liquid. Attempts have been made to prepare concentrated aqueous colloidal or other suspensions of agrochemicals, but these have generally suffered from poor stability leading to sedimentation on standing, or high viscosity leading to difficulties in handling and diluting.

EP 0 388 239 describes the use of aqueous based structured surfactants to suspend water insoluble agrochemicals. One disadvantage of using aqueous based systems is that many sparingly soluble agrochemicals exhibit crystal growth when suspended in an aqueous medium, as a consequence of Ostwald ripening. This may render colloidal particles too large to remain in suspension by Brownian motion, or may create crystals which are too coarse for conventional handling or use, even in structured systems.

We have found that water insoluble and sparingly water soluble agrochemcials may be suspended in structured surfactants of the invention without experiencing crystal growth, this permits the preparation of pourable “superconcentrates” which are stable, for long term storage, and which may be diluted with water directly to the final working concentrations prior to application. Optionally the super concentrate may be formulated so as to be dilutable to an intermediate concentration, at which it forms a stable, aqueous-based, structured surfactant suspension suitable for short term storage on site, immediately prior to final dilution.

The invention therefore, according to a particular embodiment, provides an agrochemical suspension comprising an anhydrous structured surfactant as claimed or described herein and a water insoluble or sparingly soluble agrochemical suspended therein.

The suspended biocidal or agrochemical active substance may comprise one or more agrochemicals or biocides such as selective or broad spectrum herbicides, defoliants, insecticides, miticides, moluscicides, nematicides and other vermicides, fungicides, bactericides, viricides and other pesticides, plant nutrients or growth development regulators.

The particle or droplet size of the suspended material may vary widely. The maximum size that can be stably suspended depends upon the density of the suspended phase and the Yield Point of the suspending medium. However, for practical purposes we prefer that the maximum particle size is less than 1 mm, preferably less than 500 microns. Most preferably the mean particle size and majority of the particles are in the range 0.01 to 250 microns e.g. 0.05 to 200 especially 0.11 to 100 microns. Often the mean particle size is between 0.1 and 10 microns.

Where the active substance is a low melting solid, it is sometimes desirable to incorporate a small amount of a melting point depressant to inhibit phase changes during manufacture or storage of the composition. Such changes may give rise to instability.

Examples of suitable active substances include ethofumesate, phenmedipham, dazomet, mancozeb, methylene bis thiocyanate, amitraz and triforine.

Extrudable Pastes

Compositions of our invention may be packed in flexible tubes of the type which is sealed at one end and provided at the other end with a nozzle through which the contents of the tube may be extruded by applying pressure. This is applicable to the more viscous compositions including those which consist predominantly of batonettes. Extrudable pastes may for example be used as dentifrices. Such compositions may include abrasives, peroxides or other bleach, fluoride and flavourings.

Lubricants

Structured surfactants according to the invention may be used in lubricating oils to prevent sludge deposition, to improve Theological properties or to suspend solid lubricants such as graphite or molybdenum disulphide. It has further been found that structured surfactants of the invention improve the extreme pressure wear characteristics of lubricating oils and greases. The invention may also be applied to cutting oils to assist the removal of swarf.

Fuel Oil

Compositions of the invention may be formulated with a fuel oil as the continuous phase and a solid particulate fuel, such as powdered coal or other carbonaceous or combustible material as the suspended solid.

Paints

Structured surfactants of the invention may be used to suspend pigments in oil based paint formulations or as the oil phase of an emulsion paint. The continuous phase may comprise a volatile oil or solvent and a drying oil such as linseed oil and/or any other film forming polymer or its precursor. It may be applied as such or emulsified in water.

Magnetic Liquids

Suspending systems of the present invention may be used to suspend magnetic or magnetisable particles, e.g. particles of magnetite or other ferrites including spinels, garnets and hexagonal ferrites, iron or ferromagnetic alloys such as iron/nickel, iron/cobalt and iron/silicon alloys.

The compositions may function as magnetic seals. For example the magnetic liquids provide effective seals for vacuum or pressure chambers, lubricants and sealants for vacuum pumps or to protect electronic equipment or electronic or biotechnological production facilities against chemical or biological contamination. The compositions may provide damping for audio systems. The compositions may also be used in accelerometers or inclinometers, as abrasives or as liquid magnets, may be magnetically pumped, or may be used for coating or imprinting surfaces with magnetic deposits, e.g. magnetic ink for use in ink jet printers, using magnetic fields to control deposition of the ink, or in the manufacture of magnetic tape, or in the fabrication of magnetic ceramic bodies, e.g. by cosuspending magnetic particles and silica gel, and curing the silica. Magnetic liquids according to the invention may also be used to target the delivery of medicaments within the body. Magnetic control or the optical properties of the liquids e.g. birefringence and transmissvity is also possible. The suspending system of the invention may similarly be used for suspending ferroelectric particles.

Structure

The system is believed typically to comprise spheroidal bodies formed from substantially concentric bilayers of the dispersed (usually ionic) surfactant in a liquid (usually non-ionic) continuum and packed sufficiently closely to form a solid-suspending system. The system may comprise prolate spheruloids, “batonettes” and/or solid crystals, as well as spherulites. However we prefer products with at least a major proportion of spherulites, because they are usually less viscous. Expanded Lα-phases may also be obtained. The d-spacing according to small angle x-ray diffraction is typically between 3.5 and 6 nm e.g. 4 to 5.5 nm often with first, second and even third order peaks visible. The d-spacing has often been found to correspond to the chain length of the cis monounsaturated alkenyl group. Calcium oleate gives a d-spacing of 4.7 nm while calcium erucate give a spacing of 5.7 nm. The ratio 4.7:5.7 is substantially the same as the ratio of the number of carbon atoms in the oleyl chain (18) to the number of carbon atom in the erucyl chain (22). A calcium soap of mixed oleic and erucic acids gave a sharp peak corresponding to a d-spacing of 5.2 nm. The calcium salt of oleyl triethoxy phosphoric acid gave a broader peak corresponding to d-spacing of 5.1 nm.

We generally find that surfactants comprising cis monounsaturated alkenyl groups of mixed chain lengths form spherulites more readily than those of homogeneous chain length

Stability

“Stable” in the present context implies that any solid or other suspended phase is stably suspended and does not sediment out as a separate phase. We do not exclude the possibility of a small amount of separation of a clear liquid phase, (syneresis). For some purposes relatively high levels of syneresis can readily be tolerated, e.g. in unit dose liquid detergent sachets, especially if the appearance of the product is preserved e.g. by the use of opacifiers. However, for most purposes we prefer that any such separate phase should be less than 10%, more preferably less than 5% most preferably less than 3% of the total volume after one month. We particularly prefer that any separation be less than 5% after three months, especially, less than 2% after three months. Unlike most conventional aqueous structured systems, syneresis in the systems of the present invention usually manifests itself as a clear upper layer (top separation).

Stable suspensions are most readily obtained when the total dispersed surfactant present as spherulites is sufficient to pack the system, preventing sedimentation. The presence of suspended solid, liquid or gas may contribute to packing. Typically a packed system may be obtained by preparing an unpacked spherulitic system and adding particulate solid. Alternatively it is possible to allow the unpacked system to stand until separation is substantially complete and decant the separated clear layer. The separation may be speeded by centrifuging at low G, eg 2 to 20 G. The spherulites tend to be concentrated sufficiently to form a suspending system. Centrifuging at higher G, e.g. 100 to 1000 G preferably 200 to 800 G especially 400 to 700 G, tends to pack the spherulites together to form a very viscous layer which can however be readily dispersed in the clear supernatant liquor to restore the original composition.

We do not exclude the use of auxiliary stabilisers, such as cross linked polyacrylates, alginates or carbohydrates, or branched polymers of the sort described in WO 01/00779 to inhibit or prevent syneresis.

Viscosity

For most purposes we prefer compositions with a viscosity, measured at 21 sec⁻¹ shear rate, less than 1 Pa s, especially less than 0.5 Pa s. However for some applications higher viscosities, e.g. as high as 5 Pa s or even 11 Pa s may be acceptable. Viscosities above about 11.5 Pa s are generally not pourable. Higher viscosities are generally obtained when the proportion of saturated alkyl groups in the dispersed phase the total proportion of the dispersed phase, the proportion of suspended solid and/or the proportion of higher mole weight non-ionic surfactant in the continuous phase are increased.

Temperature

We have found that the temperature of mixing may affect the form of the product especially in systems containing relatively high proportions of saturated and/or of polyunsaturated aliphatic groups. There may be a critical lower temperature below which spherulites, or other structuring features are not formed. Slightly higher temperatures promote the formation of a spherulitic system. Above a critical upper temperature the system tends to flocculate to form a stiff paste which is difficult to deflocculate. The values of these critical upper and lower temperatures vary for different dispersed surfactants. We believe that they are dependent, among other factors, on the proportion of cis mono unsaturated alkenyl groups in the feedstock. For example a soap formed from a coconut fatty acid containing 16% oleic acid by reacting with calcium hydroxide gave a critical lower temperature of about 40° C. and critical upper temperature of about 60° C. whereas soaps made from oleic acid or from mixtures of oleic and erucic acids, formed stable systems readily when mixed at room temperature.

Preparation

The composition may be prepared by mixing the ingredients at a suitable temperature, e.g. up to 60° C. However we prefer to prepare the anionic components such as calcium soaps by neutralising the precursor acids in situ using calcium hydroxide or a mixture of hydroxide and oxide. In order to obtain more rapid neutralisation we particularly prefer reacting the acid precursors with an aqueous solution of a water soluble salt of the divalent metal, e.g. aqueous calcium chloride and an aqueous alkali metal base such as sodium or potassium hydroxide. Where elevated temperatures are required, heat of neutralisation may provide the desired temperature, but it is sometimes desirable to maintain the temperature by warming for from 20 minutes to 3 hours. The reaction may be catalysed by the presence of a Lewis acid. Among preferred catalysts are aluminum chloride and ammonium chloride e.g. in amounts of from 0.01 to 10% by weight e.g. 0.1 to 2% especially 0.5 to 1%.

Fractionation

The formation of spherultic systems may be used to separate cis mono unsaturated-rich fractions from fatty acid feedstocks. The calcium soaps or corresponding betaines derived from an impure feedstock may be dispersed in a suitable organic solvent to form a non-packed spherulitic system and the spherulites concentrated by centrifuging. The saturated fractions remain in the supernatant layer which may be decanted.

The invention is illustrated by the following examples in which all percentages are by weight of active ingredient based on total weight of the composition unless otherwise stated.

### EXAMPLE 1

A suspending system comprising 20% by weight anionic surfactant and 76% non-ionic surfactant was prepared by blending a 3:1 weight/weight mixture of fatty acid and C₁₀₋₁₄ alkyl benzene sulphonic acid with C₁₂₋₁₄ alkyl-2 mole ethoxylate, and neutralising with monoethanolamine. Except where specified to the contrary the term “fatty acid” used in this and subsequent examples refers to a distilled palm kernel fatty acid sold under the Registered Trademark “PRIFAC” 7908 and having the following composition:

| Acid | % by wt. |
|---|---|
| C₈ + C₁₀ | 2 |
| C₁₂ | 49 |
| C₁₄ | 18 |
| C₁₆ | 10 |
| (stearic | 3 |
| C₁₈-(Oleic | 16 |
| (Linoleic | 2 |

The mixture was stirred with 4% by weight calcium hydroxide and warmed to a temperature of 40 to 50° C. Stirring was continued for 30 minutes. The product comprised well defined spherulites with a d spacing of 3.5 nm.

### EXAMPLE 2

10% calcium stearate was stably suspended in 90% C₁₂₋₁₄ 2 mole etloxylate by warning to 45° C. with 1% added water. The composition was viscous and poured very slowly consisting exclusively of batonettes.

### EXAMPLE 3

The following composition was stirred at 45° C. for 2 hours.

| Wt % ai | |
|---|---|
| 4.15 | C₁₀₋₁₄ alkyl benzene sulphonic acid (mean mole wt. 326) |
| 12.5 | fatty acid |
| 3.85 | monoethanolamine |
| 0.5 | C₁₀₋₁₈ alkyl 50 mole ethoxylate |
| 4.0 | calcium hydroxide |
| 75 | C₁₂₋₁₄ alkyl 2 mole ethoxylate |

The composition was a packed, spherulitic system with a viscosity of 0.4 Pa s at 21 sec⁻¹ shear rate.

### EXAMPLE 4

| | Wt % |
|---|---|
| Suspending medium of Example 3 | 67.25 |
| High phase 1 sodium tripolyphosphate 6% moist | 15.5 |
| Sodium carboxymethyl cellulose | 0.25 |
| Milled sodium perborate | 15 |
| Tetracetyl ethylene diamine | 2 |

A sample of the above formulation was poured into a polyvinyl alcohol sachet so as to partially fill it, and the sachet was sealed. After 2 weeks storage at 40° C. no evidence of evolution of oxygen or seepage through the sachet was observed.

The combination of bleach and bleach activator was stable in the liquid, despite the presence in the composition of water of neutralisation. It is assumed that the latter is incorporated into the spherulites and so effectively isolated from the bleach. When the experiment was repeated adding 5% water to the suspending system to facilitate the formation of spherulites, the sachet burst within 12 hours due to the pressure of gas evolved by the bleach.

### EXAMPLE 5

The following composition was stirred at 45° C. for 2 hours.

| Wt % ai | |
|---|---|
| 78 | C₁₂₋₁₄ alkyl 2 mole ethoxylate |
| 4.3 | C₁₀₋₁₄ alkyl benzene sulphonic acid |
| 13 | fatty acid |
| 0.5 | C₁₀₋₁₈ alkyl 50 mole ethoxylate |
| 4.2 | calcium hydroxide |

The composition was spherulitic but unpacked.

After 3 weeks standing the composition had separated into two layers. The lower layer was separated out as a mobile, packed, spherulitic suspending medium.

### EXAMPLE 6

The following composition was stirred at 45° C. for 2 hours.

| Wt % ai | |
|---|---|
| 3.1 | C₁₀₋₁₄ alkyl benzene sulphonic acid |
| 9.2 | fatty acid |
| 2.9 | monoethanolamine |
| 0.8 | C₁₀₋₁₈ alkyl 50 mole ethoxylate |
| 4.0 | calcium hydroxide |
| 80.0 | C₁₂₋₁₄ alkyl 2 mole ethoxylate |

The product was a mobile unpacked spherulitic composition. On addition of an equal weight of a 3:2 wt. wt. finely milled mixture of sodium tripolyphosphate and sodium perborate a stable suspension was formed comprising 30% tripolyphosphate 20% perborate and 50% surfactant. The perborate showed no signs of decomposition after three months.

### EXAMPLE 7

The following ingredients were mixed for 2 hours at 45° C. to form a highly viscous suspending medium consisting essentially of batonettes.

| Wt % ai | |
|---|---|
| 78 | C₁₂₋₁₄ alkyl 2 mole ethoxylate |
| 12 | stearic acid |
| 5 | C₁₀₋₁₄ alkyl benzene sulphonic acid |
| 2 | monoethanolamine |
| 3% | calcium hydroxide |

### EXAMPLES 8 TO 13

A series of compositions were prepared of the formula:

| % w/w | |
|---|---|
| 16% | anionic surfactant acid |
| 80% | C₁₂₋₁₄ alkyl six mole ethoxylate |
| 4% | calcium hydroxide |

Each was stirred for 3 hours at 45° C. The anionic surfactant was varied as follows:

| | | | | | | |
|---|---|---|---|---|---|---|
| Example | 8 | 9 | 10 | 11 | 12 | 13 |
| Wt % alkylbenze sulphonic acid | 0 | 2 | 3 | 4 | 6 | 8 |
| Wt % fatty acid | 16 | 14 | 13 | 12 | 10 | 8 |

All the examples gave spherulitic suspending systems with best mobility and stability shown by examples 9, 10 and 11, especially 10.

### EXAMPLES 14 TO 17

Example 10 was repeated using, respectively, C12-14 alkyl 2 mole, 3 mole and 8 mole ethoxylates and ethylene oxide/propylene oxide block copolymer sold under the Registered Trademark PLURAFAC LF 403 instead of the 6 mole ethoxylate. In each case a pourable, spherulitic suspending system was obtained.

### EXAMPLE 18

The following composition was prepared:

| | % w/w |
|---|---|
| C₁₂₋₁₄ alkyl 6 mole ethoxylate | 47.3 |
| C₁₀₋₁₄ alkyl benzene sulphonic acid | 1.8 |
| fatty acid | 7.8 |
| C₁₀₋₁₄ alkyl 50 mole ethoxylate | 0.3 |
| calcium hydroxide | 2.5 |
| sodium tripolyphosphate (anhydrous | 40.0 |
| polyethylene glycol (m.w. = 600) | 0.3 |

The calcium hydroxide and the fatty and sulphonic acids were stirred in the non-ionic surfactant at 45° C. for 3 hours and the tripolyphosphate and polyglycol added.

The composition was spherulitic and pourable after six weeks.

### EXAMPLE 19

A mixture 4:6 parts by weight spray dried cocoamidopropyl betaine and C₁₂₋₁₄ six mole ethoxylate was diluted with 20% by weight glycerol to provide a mobile expanded Lα-phase with good suspending properties.

20% by weight of the composition of ethyleneglycol distearate pearliser was suspended in the composition to form a pourable suspension with good pearlising properties.

### EXAMPLE 20

| | % w/w |
|---|---|
| C₁₂₋₁₄ alcohol 2 mole ethoxylate | 44.7 |
| Calcium C₁₂₋₁₄ alkyl benzene sulphonate | 2.2 |
| fatty acid | 9.7 |
| C₁₂₋₁₄ alkyl 50 mole ethoxylate | 0.4 |
| Calcium hydroxide | 3.0 |
| Sodium tripolyphosphate monohydrate | 40.0 |

The above liquid laundry detergent formulation was a pourable, non-sedimenting, spherulitic composition. It can be packed in 88% hydrolysed polyvinyl acetate sachets and heat sealed to provide water soluble unit doses of detergent.

### EXAMPLE 21

Example 19 was repeated replacing the sodium tripolyphosphate with a mixture of sodium tripolyphosphate, sodium perborate and sodium tetracetylethylene diamine in a weight ratio of 5:2:1. No evolution of gas was observed over a period of three months.

### EXAMPLE 22

10% of a fluid mixture of oleic and erucic acids was stirred with 47% C₁₂₋₁₄ alcohol 2 mole ethoxylate 3% calcium hydroxide and 40% sodium tripolyphosphate monohydrate at room temperature. A packed spherulitic composition of low viscosity was obtained.

### EXAMPLE 23

Example 22 was repeated three times using elaidic, linoleic and linolenic acids respectively instead of oleic/erucic. An immobile paste of interlocking batonettes was obtained in each case.

### EXAMPLE 24

The following composition provided a spherulic formulation which remained pourable after standing for three months:

| | % w/w |
|---|---|
| Oleic acid | 6 |
| Erucic acid | 4 |
| C₁₂₋₁₄ alkyl 3 mole ethoxylate | 75 |
| Calcium hydroxide | 3 |
| Sodium perborate monohydrate | 7 |
| Industrial methylated spirits | 5 |

### EXAMPLES 25 TO 29

| | % w/w | | | | |
|---|---|---|---|---|---|
| Component | Ex. 25 | Ex. 26 | Ex. 27 | Ex. 28 | Ex. 29 |
| Oleic Acid | 5 | 6 | 6 | 10 | 10 |
| Eurcic Acid | 5 | 4 | 4 | — | — |
| C₁₂₋₁₄ 3 mole ethoxylate | 51 | 54 | — | 44 | 29 |
| C₁₂₋₁₄ 6 mole ethoxylate | | | 29 | | |
| Ethylene oxide/proplyene | — | — | 25 | — | — |
| oxide block copolymer | | | | | |
| Sorbitan Mono oleate 20 | — | — | — | 10 | — |
| mole ethoxylate | | | | | |
| Sorbitan monolaurate 20 | — | — | — | — | 25 |
| mole ethoxylate | | | | | |
| Fatty alkyl 50 mole | 0.5 | — | — | — | — |
| ethoxylate | | | | | |
| Sodium tripolyphospate | 25 | 33 | 26 | 26 | 26 |
| Ca(OH)₂ | 3 | 3 | 3 | 3 | 3 |
| Sodium perborate | 10.5 | — | 7 | 7 | 7 |
| monohydrate | | | | | |

All samples were spherulitic, low viscosity, opaque, white liquids.

### EXAMPLES 30 TO 34

| | % w/w | | | | |
|---|---|---|---|---|---|
| | Example | | | | |
| | 30 | 31 | 32 | 33 | 34 |
| Oleic acid | 10 | 10 | 10 | 10 | 10 |
| Calcium hydroxide | 2.5 | 2.5 | 2.5 | 2.5 | 2.5 |
| C₉₋₁₁ alkyl 6 mole ethoxylate | 48.5 | 46.5 | 50 | 50 | 49 |
| Ethylene glycol | 3 | 3 | 3 | 0 | 0 |
| Polyethylene glycol (MW = 200) | 1 | 3 | 0 | 0 | 0 |
| Sodium tripolyphosphate | 35 | 35 | 35 | 35 | 35 |
| capryl 5 mole ethoxy carboxylic acid | 0 | 0 | 0 | 0.5 | 0 |
| polyethylene glycol (MW = 400) | 0 | 0 | 0 | 0 | 1 |

All the above samples were spherulitic compositions having a d-spacing under small angle X-ray diffraction of 4.7 nm. They were pourable suspensions at ambient temperature.

### EXAMPLE 35

Example 29 was repeated with 10% by weight erucic acid in place of the oleic acid. The product was pourable suspension at ambient temperature. It had a spherulitic structure with a d-spacing of 5.7 nm.

### EXAMPLE 36

Example 29 was repeated with 6% oleic and 4% by weight erucic acids the product was spherulitic with a d-spacing of 5.2 nm.

### EXAMPLE 37

Oleyl betaine formed a pourable spherulitic suspending system in light mineral oil at concentrations between 10 and 30% by weight.

### EXAMPLE 38

The following mixture was stirred for 2 hours:

| | Parts by weight |
|---|---|
| C₁₂₋₁₄ alkyl 3 mole ethoxylate | 20 |
| C₉₋₁₁ branched alkyl 6 mole ethoxylate | 20 |
| Oleic acid | 10 |
| H₂O | 5 |
| Ca(OH)₂ | 1.6 |

Then the following were stirred into the mixture

| | Parts by weight |
|---|---|
| oleyl 3 mole ethoxy phosphoric acid | 9 |
| diethylene triamine pentakis | 1 |
| (methylenephosphonate) | |
| Sodium tripolyphosphate | 38 |

The mixture was a stable packed spherulitic composition with a lamellar small angle x-ray peak corresponding to a d-spacing of 51 Å.

### EXAMPLE 39

Ethylene diamine was reacted with an equimolar proportion of oleic acid in an equimolar mixture of C₉₋₁₁ branched alkyl 6 mole ethoxylate and C₁₂₋₁₄ branched straight chain 3 mole ethoxylate. The product was a mobile, spherulitic composition.

### EXAMPLE 40

The following formulation was prepared:

| | % w/w |
|---|---|
| C₁₂₋₁₅ branched alkyl 3 mole ethoxylate | 17.7 |
| C₉₋₁₁ branched alkyl 6 mole ethoxylate | 17.7 |
| Oleic acid | 7 |
| Water | 4.6 |
| Calcium hydroxide | 1.1 |
| Mono/di (oleyl 3 mole ethoxy) phosphoric acid | 10 |
| Sodium diethylenetriamine | 1 |
| pentakis (methylenephosphonate) | |
| Silicone anitfoam | 0.3 |
| Sodium tripolyphosphate | 36 |
| Ethylene glycol | 3 |

The product was a stable, pourable, spherulitic composition. It was packed into polyvinyl alcohol sachets to form a stable, non-sweating, non-crusting product which readily dissolved in wash liquor.

### EXAMPLE 41

The following formulation was prepared:

| | % w/w |
|---|---|
| C₁₂₋₁₅ branched alkyl 3 mole ethoxylate | 17.5 |
| C₉₋₁₁ branched alkyl 6 mole ethoxylate | 17.5 |
| Oleic acid | 7 |
| Water | 1 |
| Potassium hydroxide | 2.85 |
| Calcium chloride dihydrate (50% solution in water) | 3.75 |
| Mono/di (oleyl 3 mole ethoxy) phosphoric acid | 10 |
| Sodium diethylenetriamine | 1 |
| pentakis (methylenephosphonate) | |
| Sodium tripolyphosphate | 36 |
| Ethylene glycol | 3 |

The product formed a mobile, stable, spherulitic detergent composition with good washing properties.

### EXAMPLE 42

The following composition was prepared:

| | % w/w |
|---|---|
| C₁₂₋₁₅ branched alkyl 3 mole ethoxylate | 18 |
| C₉₋₁₁ branched alkyl 6 mole ethoxylate | 18 |
| Oleic acid | 7 |
| Water | 1.25 |
| Sodium hydroxide (50% solution in water) | 2.05 |
| Calcium chloride dihydrate (50% solution in water) | 3.75 |
| Mono/di (oleyl 3 mole ethoxy) phosphoric acid | 10 |
| Sodium diethylenetriamine | 1 |
| pentakis (methylenephosphonate) | |
| Silicone antifoam | 0.25 |
| Sodium tripolyphosphate | 36 |
| Ethylene glycol | 2.7 |

The product formed a mobile, stable, spherulitic detergent composition with good washing properties.

### EXAMPLE 43

A fabric conditioning concentrate was prepared comprising 18% by weight dierucyl dimethylammonium methosulphate in a mixture of equal parts by weight of C₉₋₁₁ branched alkyl 6 mole ethoxylate and C₁₂₋₁₅ branched alkyl 0.3 mole ethoxylate. The product was a readily pourable, stable spherulitic concentrate with excellent fabric conditioning performance. The product can be used to suspend clays such as bentonite or synthetic layer silicates.

### EXAMPLE 44

5 gm of a mixed mono/di-(oleyl 10 mole ethoxy) phosphoric acid was stirred into a mixture of 18.5 gm of C₁₂₋₁₅ branched alkyl three mole ethoxylate an 18.5 gm C₉₋₁₁ branched chain alkyl six mole ethoxylate. 0.5 gm calcium hydroxide in 4.5 gm water was added with stirring. A stable, mobile, spherulitic suspending liquid was obtained which gave less than 1 mm clear lower syneresis after 10 minutes centrifuging at 20,000 G.

### EXAMPLE 45

Example 44 was repeated using an equivalent weight of isostearic acid in place of the oleyletherphosphoric acid. A stable mobile, spherulitic suspending system was obtained.

### EXAMPLE 46

2 moles of C₁₂₋₁₄ alkyl benzene sulphonic acid were reacted with 1 mole ethylene diamine to form the ethylene diamine bis (alkylbenzene sulphonate) salt. A 15% by weight solution of the salt in the non-ionic surfactant system of example 43 gave a stable, mobile composition comprising small batonettes and having good suspending power.

### EXAMPLE 47

The calcium salt of C₁₂₋₁₄ linear alkyl benzene sulphonate was prepared and was found to provide a mobile, stable Lα structured system with solid suspending properties at a concentration of 18% by weight in light mineral oil.

### EXAMPLE 48

The erucate salt of the bis erucyl ester of methylated triethanolamine formed a spherulitic structured system in the non-ionic surfactant system of Example 43.

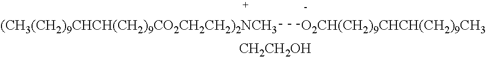

### EXAMPLE 49

The calcium salt of oleyl 10 mole ethoxy sulphate formed a spherulitic suspending system at a concentration of 18% by weight in the non-ionic surfactant system of example 43.

### EXAMPLE 50

Calcium isostearyl sulphate formed a stable spherulitic structured system at a concentration of 18% by weight in the non-ionic surfactant system of example 43.

### EXAMPLE 51

Calcium 3 isostearyl mole ethoxy sulphate at a concentration of 17% by weight in the non-ionic liquid surfactant systems of Example 43 formed a stable spherulitic suspending system.

### EXAMPLE 52

Calcium isostearyl 10 mole ethoxylate sulphate formed a stable spherulitic suspending system at a concentration of 18% by weight in the non-ionic surfactant system of Example 43.

1. A structured surfactant composition having solid suspending properties and comprising a substantially non-aqueous continuous liquid phase and a structuring surfactant which is present in excess of its solubility in the continuous phase and is present as an Lα phase.

2. A composition according to claim 1 wherein said structuring-surfactant has a solubility in said liquid phase greater than a minimum of 1% and less than a maximum of 25% by weight.

3. A composition according to claim 2 wherein said solubility is between a minimum of 4% and a maximum of 20%.

4. A composition according to either of claims 2 and 3 wherein the structuring-surfactant comprises a minimum of a surfactant having a solubility in said liquid phase less than said maximum and a surfactant having a solubility in said liquid phase greater than said maximum in a relative proportion adapted to provide a mean solubility between said minimum and said maximum.

5. A composition according to any of claims 2 to 4 wherein said liquid phase comprises a mixture of at least two liquids of different polarity, in at least one of which the solubility of the structuring-surfactant is outside the range between said minimum and said maximum.

6. A composition according to any foregoing claim wherein said structuring surfactant is present as batonettes, spherulites and/or expanded lamellar phase.

7. A composition according to any foregoing claim wherein said structuring-surfactant is an anionic or cationic surfactant having at least two hydrophobic aliphatic groups per molecule with from 7 to 30 carbon atoms each.

8. A composition according to claim 7 wherein said surfactant is a salt of a divalent metal or base and an acid having at least one C₇ to 30 aliphatic groups.

9. A composition according to claim 8 wherein said divalent metal or base is calcium or 1,2-diaminoethane.

10. A composition according to either or claims 8 and 9 wherein said acid is a phosphoric, phosphonic, sulphuric, sulphonic or carboxylic acid.

11. A composition according to claim 10 wherein said acid comprises an alkyl or alkenyl sulphuric acid, an alkyl or alkenyl benzene sulphonic acid, a mono and/or di alkyl or alkenyl phosphoric acid, a fatty acid or an alkyl or alkenyl ethoxy or polyethoxy analogue of any of the aforesaid acids.

12. A composition according to claim 7 wherein said structuring-surfactant is a cationic surfactant having at least two C₇ to 30 aliphatic groups in the cation.

13. A composition according to any of claims 1 to 6 wherein said structuring-surfactant wherein said structuring-surfactant comprises an amphoteric surfactant or amine oxide with a least one C₇ to 30 aliphatic group.

14. A composition according to any of claims 1 to 6 wherein said structuring surfactant comprises a surfactant anion with at least one C₇ to 30 aliphatic group and a surfactant anion with at least one C₇ to 30 aliphatic group.

15. A composition according to any foregoing claim wherein said continuous phase comprises at least 50% by weight thereof of a non-ionic surfactant.

16. A composition according to any foregoing claim wherein said continuous phase comprises a non surfactant hydroxylic solvent.

17. A composition according to any foregoing claim wherein said continuous phase comprises a water immiscible organic liquid.

18. A composition according to any foregoing claim wherein said structuring-surfactant comprises a spherulite-forming surfactant wherein said C₇ to 30 aliphatic group comprises a bent alkyl or alkenyl chain.

19. A composition according to claim 18 wherein said structuring surfactant is present, at least predominantly as spherulites.

20. A composition according to claim 18 wherein said bent alkyl or alkenyl chain comprises a group of formula:
CH₃(CH₂)ₙX(CH₂)ₘ—
wherein n and m are each independently from 3 to 15, preferably 4 to 12 e.g. 5 to 10 and X a is non-linear non-hydrophilic group having from 1 to 4 carbon atoms such as cis-CH═CH,
or 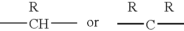
group, where R is C₁₋₄ alkyl, preferably methyl, or a 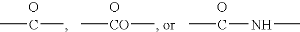
group.

21. A composition according to claim 20 wherein said bent chain aliphatic group comprises a cis monounsaturated alkenyl group.

22. A composition according to claim 21 wherein said bent chain aliphatic group comprises an oleyl or erucyl group.

23. A composition according to claim 20 wherein said bent chain aliphatic group comprises an isostearyl or isopalmityl group.

24. A substantially non-aqueous suspension comprising a structured surfactant composition according to any foregoing claim; and a non-colloidal particulate phase which is substantially immiscible with the continuous liquid phase and which is held in suspension therein by the structured surfactant.

25. A composition according to any foregoing claim wherein said suspended phase comprises a solid builder and/or an abrasive.

26. A composition according to claim 24 wherein said continuous medium is substantially anhydrous and said particulate phase comprises a water sensitive material.

27. A composition according to claim 26 wherein said water sensitive material is a peroxy bleach optionally with a bleach activator.

28. A composition according to claim 27 additionally containing a tertiary amine or salt thereof.

29. A composition according to any foregoing claim in the form of a unit dose packed in a water soluble sachet or capsule.

30. A detergent composition according to claim 1 comprising (A) a substantially non-aqueous continuous phase consisting essentially of C₈₋₁₄ alkyl or alkenyl 1 to 10 mole ethoxylates; (B) from, 4 to 35% by weight of the composition of a spherulite forming surfactant present at least partly as spherulites and comprising an anionic surfactant with at least two C₇ to 30 hydrophobic aliphatic groups per molecule or an amphoteric surfactant or amine oxide with at least one hydrophobic C₇ to ₃₀ aliphatic group per molecule, said aliphatic groups comprising bent chain aliphatic groups; (C) a solid, particulate builder
